(19) United States
(12) Patent Application Publication
(10) Pub. No.: US 2025/0124331 A1
(43) Pub. Date: Apr. 17, 2025

(54) COMPUTER-IMPLEMENTED METHOD, APPARATUS, COMPUTER-PROGRAM PRODUCT

(71) Applicant: BOE Technology Group Co., Ltd., Beijing (CN)

(72) Inventor: Longfei Li, Beijing (CN)

(73) Assignee: BOE Technology Group Co., Ltd., Beijing (CN)

(21) Appl. No.: 18/293,908

(22) PCT Filed: Nov. 30, 2022
(86) PCT No.: PCT/CN2022/135337

§ 371 Date: Jan. 31, 2024

(51) Int. Cl. G06N 20/00

(52) U.S. Cl. CPC G06N 20/00

(57) ABSTRACT

A computer-implemented method is provided. The computer-implemented method includes obtaining a bipartite network; a first multi-view homogeneous network; and a second multi-view homogeneous network; performing an embedding learning process for the bipartite network; performing an embedding learning process for the first multi-view homogeneous network; performing an embedding learning process for the second multi-view homogeneous network; and predicting association relationships between nodes of a first object type and nodes of a second object type.

### TECHNICAL FIELD

The present invention relates to display technology, more particularly, to a computer-implemented method, an apparatus, and a computer-program product.

### BACKGROUND

Information network representation learning (also known as representation learning or embedding learning) embeds nodes into a low-dimensional vector space using information such as the topology of the network and the content of the nodes, while preserving the inherent structure and content characteristics of the network. Examples of information networks include homogeneous information networks and heterogeneous information networks. Homogeneous information networks have with only one node type and one edge type. Homogeneous information networks are a simplification of real information networks, often extracting only part of the information of real information networks, or not distinguishing the differences of objects and relationships in real networks, resulting in incomplete or lost information. Models such as DeepWalk and LINE have been used on network representation learning of homogeneous information networks.

### SUMMARY

In one aspect, the present disclosure provides a computer-implemented method, comprising obtaining a bipartite network; a first multi-view homogeneous network; and a second multi-view homogeneous network; performing an embedding learning process for the bipartite network; performing an embedding learning process for the first multi-view homogeneous network; performing an embedding learning process for the second multi-view homogeneous network; and predicting association relationships between nodes of a first object type and nodes of a second object type.

Optionally, the bipartite network comprises nodes of a first object type, nodes of a second object type, and edges connecting the nodes of the first object type and the nodes of the second object type.

Optionally, the first multi-view homogeneous network comprises a first set of networks composed of nodes of a first object type, in which edges between a same pair of the nodes of the first type are observed in different views; and the second multi-view homogeneous network comprises a second set of networks composed of nodes of a second object type, in which edges between a same pair of the nodes of the second type are observed in different views.

Optionally, the computer-implemented method further comprises obtaining an embedding matrix representing the nodes of the first object type learned in the embedding learning process for the bipartite network; obtaining an embedding matrix representing the nodes of the second object type learned in the embedding learning process for the bipartite network; obtaining an embedding matrix representing the nodes of the first object type learned in the embedding learning process for the first multi-view homogeneous network; and obtaining an embedding matrix representing the nodes of the second object type learned in the embedding learning process for the second multi-view homogeneous network.

Optionally, the computer-implemented method further comprises combining an embedding matrix representing the nodes of the first object type learned in the embedding learning process for the bipartite network and an embedding matrix representing the nodes of the first object type learned in the embedding learning process for the first multi-view homogeneous network; and combining an embedding matrix representing the nodes of the second object type learned in the embedding learning process for the bipartite network and an embedding matrix representing the nodes of the second object type learned in the embedding learning process for the second multi-view homogeneous network.

Optionally, the computer-implemented method further comprises inputting an embedding matrix representing nodes of a first object type learned in the embedding learning process for the bipartite network into the first multi-view homogeneous network as an initialized node embedding of the first multi-view homogeneous network; and inputting an embedding matrix representing nodes of a second object type learned in the embedding learning process for the bipartite network into the second multi-view homogeneous network as an initialized node embedding of the second multi-view homogeneous network.

Optionally, performing the embedding learning process for the first multi-view homogeneous network comprises inputting M sets of node embeddings of the first object type learned from M homogeneous view networks in the embedding learning process for the first multi-view homogeneous network into an attention mechanism; and determining weights assigned to M homogeneous views respectively by the attention mechanism.

Optionally, the weights assigned to M homogeneous views respectively are expressed as (α₁^{l}, α₂^{l}, . . . , α_{M}^{l})=αttₛₑₘ(H₁₁^{l}, H₁₂^{l}, . . . , H_{1M}^{l}), l=0,1,2, . . . ; wherein (α₁^{l}, α₂^{l}, . . . , α_{M}^{l}) stands for a weight matrix comprising the weights assigned to the M homogeneous views respectively; αttₛₑₘ stands for a method of performing semantic level attention; (H₁₁^{l}, H₁₂^{l}, . . . , H_{1M}^{l}) stands for feature representations of nodes of the first object type extracted from the M homogeneous views; and l stands for a l-th layer of the attention mechanism.

Optionally, determining the weights assigned to the M homogeneous views respectively comprises performing a non-linear transformation on H₁ₘ^{l}, to transform H₁ₘ^{l} into embeddings of all nodes in a m-th view network of the M homogeneous view networks.

Optionally, the computer-implemented method further comprises fusing, by a l-th layer of the attention mechanism, different low dimensional feature representations of nodes of the first object type under different meta-paths, using the weights assigned to M homogeneous views respectively; and obtaining a low dimensional embedding representation of the nodes of the first object type from a l-th layer of the attention mechanism \tilde{H}₁^{l}=Σₘ₌₁^{M} αₘ^{l}·H₁ₘ^{l}.

Optionally, performing the embedding learning process for the second multi-view homogeneous network comprises inputting N sets of node embeddings of the second object type learned from N homogeneous view networks in the embedding learning process for the second multi-view homogeneous network into an attention mechanism; and determining weights assigned to N homogeneous views respectively by the attention mechanism.

Optionally, the weights assigned to N homogeneous views respectively are expressed as (β₁^{l}, β₂^{l}, . . . , β_{N}^{l})=αttₛₑₘ(H₂₁^{l}, H₂₂^{l}, . . . , H_{2N}^{l}), l=0,1,2, . . . ; wherein (β₁^{l}, β₂^{l}, . . . , β_{N}^{l}) stands for a weight matrix comprising the weights assigned to the N homogeneous views respectively; αttₛₑₘ stands for a method of performing semantic level attention; (H₂₁^{l}, H₂₂^{l}, . . . , H_{2N}^{l}) stands for feature representations of nodes of the second object type extracted from the N homogeneous views; and l stands for a l-th layer of the attention mechanism.

Optionally, determining the weights assigned to the N homogeneous views respectively comprises performing a non-linear transformation on H₂ₙ^{l}, to transform H₂ₙ^{l}, into embeddings of all nodes in a n-th view network of the N homogeneous view networks.

Optionally, the computer-implemented method further comprises fusing, by a l-th layer of the attention mechanism, different low dimensional feature representations of nodes of the second object type under different meta-paths, using the weights assigned to N homogeneous views respectively; and obtaining a low dimensional embedding representation of the nodes of the second object type from a l-th layer of the attention mechanism \tilde{H}₂^{l}=Σₙ₌₁^{N} βₙ^{l}·H₂ₙ^{l}.

Optionally, performing the embedding learning process for the bipartite network comprises extracting node representations of nodes of the first object type and nodes of the second object type by inputting pairs of nodes; learning sequence representations of nodes; and outputting vector representations of nodes.

Optionally, learning sequence representations of nodes is performed using a random walk algorithm; and the vector representations of the nodes are obtained using a skip-gram model.

Optionally, the nodes of a first object type are drug nodes; the nodes of the second object type are disease nodes; wherein the heterogeneous network comprises one or more drug-drug similarity matrixes and one or more disease-disease similarity matrixes; wherein the method further comprises a decoding process to reconstruct association relationships between the nodes of a first object type and the nodes of a second object type, thereby predicting drug-disease association.

Optionally, the computer-implemented method further comprises minimizing a weighted binary cross-entropy loss:

$$loss = - \frac{1}{u \times v} ( γ \times {Σ}_{( i , j ) ∈ {S}^{+}} log {A}_{i j}^{′} + {Σ}_{( i , j ) ∈ {S}^{-}} ( 1 - log {A}_{i j}^{′} ) ) ;$$

wherein (i, j) stands for a pair of drug rᵢ and disease dⱼ; S⁺ stands for a set of all known drug-disease association pairs; S⁻ stands for a set of all unknown or unobserved drug-disease association pairs;

$$γ = \frac{\vert {S}^{-} \vert}{\vert {S}^{+} \vert}$$

stands for a balancing factor for reducing an effect of data imbalance; and
   |S⁺| and |S⁻| are logarithms in S⁺ and S⁻, respectively.

In another aspect, the present disclosure provides an apparatus, comprising a memory; one or more processors; wherein the memory and the one or more processors are connected with each other; and the memory stores computer-executable instructions for controlling the one or more processors to obtain a bipartite network; a first multi-view homogeneous network; and a second multi-view homogeneous network; perform an embedding learning process for the bipartite network; perform an embedding learning process for the first multi-view homogeneous network; perform an embedding learning process for the second multi-view homogeneous network; and predict association relationships between nodes of a first object type and nodes of a second object type.

In another aspect, the present disclosure provides a computer-program product, comprising a non-transitory tangible computer-readable medium having computer-readable instructions thereon, the computer-readable instructions being executable by a processor to cause the processor to perform obtaining a bipartite network; a first multi-view homogeneous network; and a second multi-view homogeneous network; performing an embedding learning process for the bipartite network; performing an embedding learning process for the first multi-view homogeneous network; performing an embedding learning process for the second multi-view homogeneous network; and predicting association relationships between nodes of a first object type and nodes of a second object type.

### BRIEF DESCRIPTION OF THE FIGURES

The following drawings are merely examples for illustrative purposes according to various disclosed embodiments and are not intended to limit the scope of the present invention.

FIG. 1 is a diagram illustrating a computer-implemented method in some embodiments according to the present disclosure.

FIG. 2 is a flow chart illustrating a computer-implemented method in some embodiments according to the present disclosure.

FIG. 3 is a flow chart illustrating a computer-implemented method in some embodiments according to the present disclosure.

FIG. 4 is a diagram illustrating a computer-implemented method in some embodiments according to the present disclosure.

FIG. 5 is a diagram illustrating a node representation learning process in some embodiments according to the present disclosure.

FIG. 6 is a diagram illustrating a node representation learning process in some embodiments according to the present disclosure.

FIG. 7 is a schematic diagram of a structure of an apparatus in some embodiments according to the present disclosure.

FIG. 8 is a schematic diagram of a structure of an apparatus in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Heterogeneous information networks contain various types of nodes and edges, with different types of nodes representing different objects and different types of edges representing different associations between objects. For example, in a disease prevention and control network, there are objects such as doctors, patients, diseases and drugs, where doctors are connected to patients through a “treat/treated” relationship and patients are connected to medications through a “take/taken” relationship. Different types of objects and connected edges have different semantic meanings, distinguishing the differences between real-world data objects and their relationships. At the same time, information can be propagated between different objects through different types of relationships in the network, reflecting the similarity or influence between objects. Since heterogeneous information networks contain more comprehensive structural and semantic information, representation learning in heterogeneous information networks can not only effectively alleviate the problem of high-dimensional and sparse network data, but also fuse different types of heterogeneous information in the network to make the learned feature representations more meaningful and valuable. The inventors of the present disclosure discover that, due to the special characteristics of heterogeneous information networks, the representation learning methods applicable for homogeneous information networks cannot be directly applied to heterogeneous information networks. The heterogeneity of nodes and edges in a network requires that representation learning not only extracts and exploits the multidimensional information of the network comprehensively, but also fuses this information effectively, while capturing as much as possible the embedding uncertainty caused by various attributes.

Accordingly, the present disclosure provides, inter alia, a computer-implemented method, an apparatus, and a computer-program product that substantially obviate one or more of the problems due to limitations and disadvantages of the related art. In one aspect, the present disclosure provides a computer-implemented method. In some embodiments, the computer-implemented method includes obtaining a bipartite network; a first multi-view homogeneous network; and a second multi-view homogeneous network; performing an embedding learning process for the bipartite network; performing an embedding learning process for the first multi-view homogeneous network; performing an embedding learning process for the second multi-view homogeneous network; and predicting association relationships between the nodes of a first object type and the nodes of a second object type.

In a graph G=(V, E), V stands for a set of nodes; and E stands for a set of edges. A respective node v in the set of nodes V is of a respective type in a set of object types O, wherein O={type 1, type 2, . . . , type i, . . . }. A respective edge e in the set of edges E is of a respective relationship type in a set of relationship types R, wherein R={ . . . , type i-type j, . . . }; i and j are respectively types in the set of object types O. In one example, i=j, the graph is a homogeneous network graph. In another example, i=j; and type i-type j may correspond to multiple different relationships, and the graph is a multi-view homogeneous network. As used herein, the term “node” refers to a representation of an object in a graph. As used herein, the term “edge” refers to a connection or association between nodes of a graph.

In some embodiments, the set of object types O includes two object types; and the set of nodes includes nodes of two object types. The network is a heterogeneous network that can be split into a bipartite graph. In some embodiments, with respect to each object type, the set of relationship types R includes a multi-view homogeneous network. Optionally, there are multiple views for nodes of a same type, e.g., there are multiple homogeneous networks for the nodes of the same type. The multiple homogeneous networks have the same nodes, however, may have different sets of edges, or may have different weights for a same edge. A respective node in the nodes of a same type is connected to one or more nodes in the nodes of a different type.

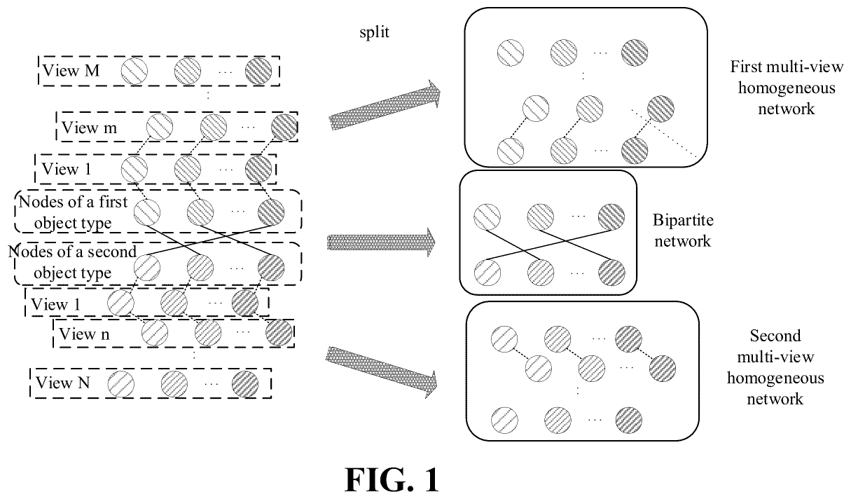

FIG. 1 is a diagram illustrating a computer-implemented method in some embodiments according to the present disclosure. Referring to FIG. 1, the computer-implemented method in some embodiments includes splitting a heterogeneous network into a bipartite network, a first multi-view homogeneous network, and a second multi-view homogeneous network. The bipartite network includes nodes of two different object types, and edges connecting nodes of the two different types. The first multi-view homogeneous network includes a first set of networks composed of nodes of a first type, in which edges between a same pair of nodes of the first type may be observed in different views. Referring to FIG. 1, the first multi-view homogeneous network may include M number of views, View 1, . . . , View m, . . . , View M, 1<m<M. The second multi-view homogeneous network includes a second set of networks composed of nodes of a second type, in which edges between a same pair of nodes of the second type may be observed in different views. Referring to FIG. 1, the second multi-view homogeneous network may include N number of views, View 1, . . . , View n, . . . , View N, 1<n<N.

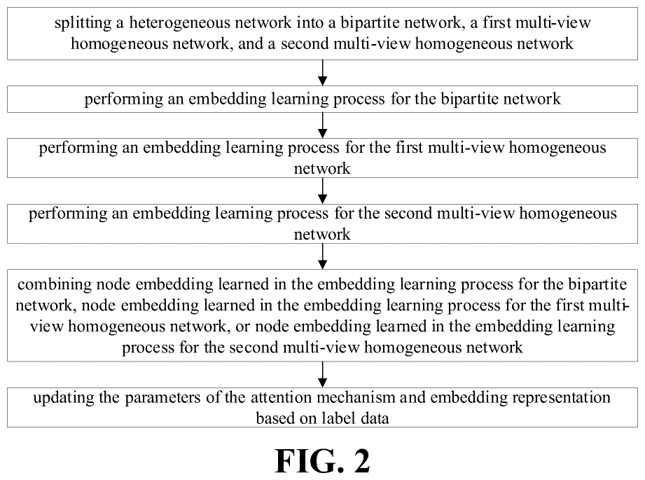

FIG. 2 is a flow chart illustrating a computer-implemented method in some embodiments according to the present disclosure. Referring to FIG. 1 and FIG. 2, the computer-implemented method in some embodiments further includes performing an embedding learning process for the bipartite network; performing an embedding learning process for the first multi-view homogeneous network; and performing an embedding learning process for the second multi-view homogeneous network.

Various appropriate algorithms may be used for embedding learning of the bipartite network. Examples of appropriate embedding learning algorithms include random walk algorithms such as Node2Vec, graph neural network methods such as graph convolutional neural network (GCN).

Various appropriate algorithms may be used for embedding learning of the first multi-view homogeneous network and the second multi-view homogeneous network. Examples of appropriate embedding learning algorithms include GCN.

In some embodiments, topological structure information of the bipartite network is learned in the embedding learning of the bipartite network. The topological structure information of the bipartite network may be used as attribute information of the nodes, which may be used in the embedding learning processes of the first multi-view homogeneous network and the second multi-view homogeneous network.

In some embodiments, in the embedding learning process for the first multi-view homogeneous network, embedding based on different multiple views (e.g., View 1, . . . , View m, . . . , View M) of the first multi-view homogeneous network is learned. In one example, because information quality of different multiple views may be different, assigned weights of the multiple views may be learned through an attention mechanism.

In some embodiments, in the embedding learning process for the second multi-view homogeneous network, embedding based on different multiple views (e.g., View 1, . . . , View n, . . . , View N) of the second multi-view homogeneous network is learned. In one example, because information quality of different multiple views may be different, assigned weights of the multiple views may be learned through an attention mechanism.

Referring to FIG. 1 and FIG. 2, the computer-implemented method in some embodiments further includes combining node embedding learned in the embedding learning process for the bipartite network, node embedding learned in the embedding learning process for the first multi-view homogeneous network, or node embedding learned in the embedding learning process for the second multi-view homogeneous network. Various combination methods may be used. In one example, the step of combining is performed by simple splicing. In another example, the step of combining is performed using an attention mechanism.

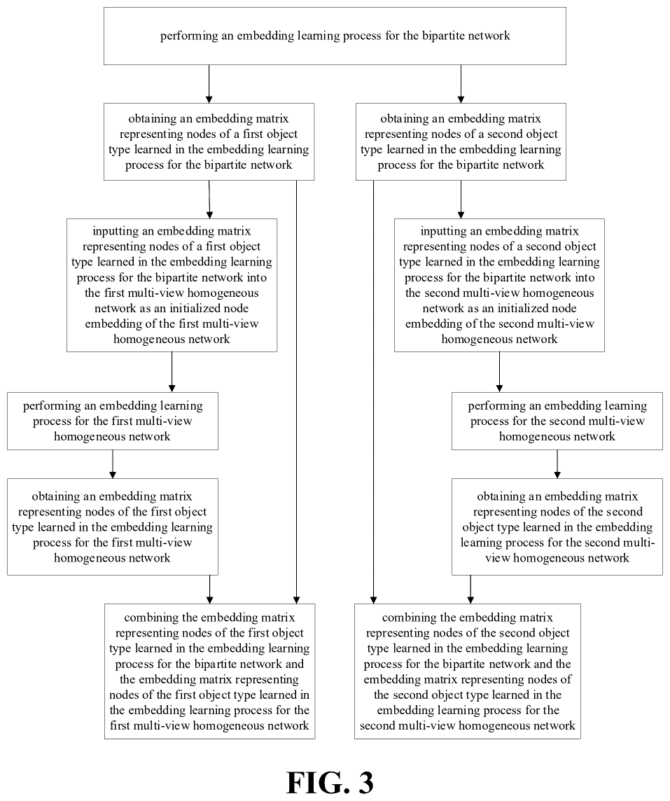

FIG. 3 is a flow chart illustrating a computer-implemented method in some embodiments according to the present disclosure. Referring to FIG. 3, subsequent to performing the embedding learning process for the bipartite network, the computer-implemented method in some embodiments further includes obtaining an embedding matrix representing nodes of a first object type learned in the embedding learning process for the bipartite network; and obtaining an embedding matrix representing nodes of a second object type learned in the embedding learning process for the bipartite network. Upon obtaining the embedding matrix representing nodes of the first object type learned in the embedding learning process for the bipartite network, the computer-implemented method in some embodiments further includes inputting an embedding matrix representing nodes of a first object type learned in the embedding learning process for the bipartite network into the first multi-view homogeneous network as an initialized node embedding of the first multi-view homogeneous network. Upon obtaining the embedding matrix representing nodes of a second object type learned in the embedding learning process for the bipartite network, the computer-implemented method in some embodiments further includes inputting an embedding matrix representing nodes of a second object type learned in the embedding learning process for the bipartite network into the second multi-view homogeneous network as an initialized node embedding of the second multi-view homogeneous network.

Referring to FIG. 3, subsequent to performing the embedding learning process for the first multi-view homogeneous network, the computer-implemented method in some embodiments further includes obtaining an embedding matrix representing nodes of the first object type learned in the embedding learning process for the first multi-view homogeneous network. Subsequent to performing the embedding learning process for the second multi-view homogeneous network, the computer-implemented method in some embodiments further includes obtaining an embedding matrix representing nodes of the second object type learned in the embedding learning process for the second multi-view homogeneous network.

Referring to FIG. 3, upon obtaining the embedding matrix representing nodes of a first object type learned in the embedding learning process for the bipartite network and obtaining the embedding matrix representing nodes of the first object type learned in the embedding learning process for the first multi-view homogeneous network, the computer-implemented method in some embodiments further includes combining the embedding matrix representing nodes of the first object type learned in the embedding learning process for the bipartite network and the embedding matrix representing nodes of the first object type learned in the embedding learning process for the first multi-view homogeneous network.

Referring to FIG. 3, upon obtaining the embedding matrix representing nodes of a second object type learned in the embedding learning process for the bipartite network and obtaining the embedding matrix representing nodes of the second object type learned in the embedding learning process for the second multi-view homogeneous network the computer-implemented method in some embodiments further includes combining the embedding matrix representing nodes of the second object type learned in the embedding learning process for the bipartite network and the embedding matrix representing nodes of the second object type learned in the embedding learning process for the second multi-view homogeneous network.

Referring to FIG. 1 and FIG. 2, the computer-implemented method in some embodiments further includes updating the parameters of the attention mechanism and embedding representation based on label data. As used herein, the term “label data” is interpreted broadly to encompass any coding that enables a feature to be delineated, segmented, or annotated.

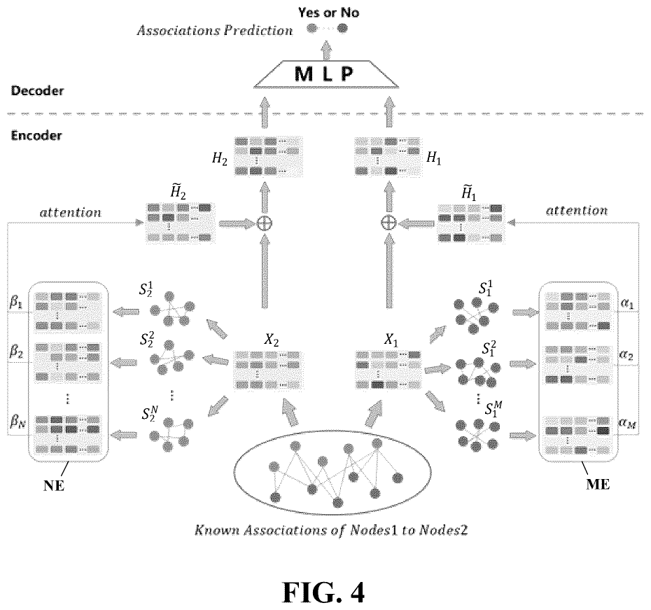

FIG. 4 is a diagram illustrating a computer-implemented method in some embodiments according to the present disclosure. Referring to FIG. 1 to FIG. 4, in some embodiments, the embedding learning process for the bipartite network comprises obtaining node representations for the nodes of two different object types in the bipartite network. Optionally, the embedding learning process for the bipartite network includes processing an association network comprising known associations of the nodes of two different object types in the bipartite network (“Known Associations of Node1 to Node2” denoted in FIG. 4). In one example, the association network may be denoted as G, nodes of the first object type may be denoted as u, and nodes of the second object type may be denoted as v.

Various low dimensional node embedding methods may be used for processing the association network. Examples of appropriate low dimensional node embedding algorithms include matrix decomposition algorithms, random walk algorithms, and neural network algorithms. As used herein, the term “embedding” refers to a vector representation of one or more object derived during a process of training or optimizing a machine-learning model to perform a prediction or classification task. In one example, embedding may refer to a vector representing a single object. In another example, embedding may refer to an output from a machine-learning model that is used as input to train or optimize another machine-learning model to perform a prediction or classification task. In another example, embedding may refer to an output from a machine-learning model after the model has been trained. As used herein, the term “low dimensional node embedding” refers to a process of embedding nodes into a low dimensional space with certain (e.g., critical) structure information reserved. In one example, similarity between nodes in the embedding space approximately equals to the similarity in the original network.

In some embodiments, an adjacent matrix A of the association network includes known associations between nodes of the first object type and nodes of the second object type. Optionally, if a node of the nodes of the first object type and a node of the nodes of the second object type are associated to each other, A(i, j)=1. Optionally, if a node of the nodes of the first object type and a node of the nodes of the second object type are not associated to each other, A(i, j)=0.

Topological structure information of the bipartite network learned in the embedding learning of the bipartite network represents the relationships between pairs of nodes, and is more complex in nature. In some embodiments, performing an embedding learning process for the bipartite network includes extracting node representations of nodes of the first object type and nodes of the second object type. Various appropriate algorithms may be used for extracting node representations of nodes of the first object type and nodes of the second object type. Examples of appropriate algorithms for extracting node representations include graph representation learning algorithms such as DeepWalk algorithms.

In some embodiments, extracting node representations of nodes of the first object type and nodes of the second object type includes inputting pairs of nodes; learning sequence representations of nodes; and outputting vector representations of the nodes. Optionally, learning sequence representations of nodes is performed using a random walk algorithm. Optionally, the vector representations of the nodes are obtained using a skip-gram model.

In a graph G=(V, E), V stands for a set of nodes; and E stands for a set of edges. An association network of the graph includes an adjacent matrix A. Optionally, a random traversal sequence from node v_0 to v_(i−1)(1≤i≤|V|, |V| is the number of nodes) is denoted as {v_0, . . . ,v_(i−1)}. Random walk is performed based on the adjacent matrix A, for example, only nodes with edges connected are walked. Optionally, the probability of reaching a next node v_i is Pr(vᵢ|(v₀, . . . , vᵢ₋₁)).

In some embodiments, the embedding learning process for the bipartite network includes obtaining node representations for the nodes of two different object types in the bipartite network, for example, obtaining vector representations of the nodes of two different object types in the bipartite network. Optionally, the embedding learning process further includes obtaining a mapping function Φ: v∈V→R^{|v|×d}. The mapping function may be interpreted as a matrix of |V|×d represented as a vector representation of each node on a d-dimensional space.

Accordingly, the probability of reaching a next node v_i may be expressed as Pr(vᵢ|Φ(v₀), . . . , Φ(vᵢ₋₁))). A skip gram model may be used for solving the equation Pr(vᵢ|(Φ(v₀), . . . , Φ(vᵢ₋₁))). In one example, the skip gram model may be expressed as:

$$\begin{matrix}minimize \\ Φ\end{matrix} - log Pr ( \{ {v}_{i - w} , … , {v}_{i - 1} , {v}_{i + 1} , … , {v}_{i + w} \} \vert Φ ( {v}_{i} ) ) = {Π}_{{j = i - w}_{j \neq i} ,}^{i + w} Pr ( {v}_{j} \vert ( Φ ( i ) ) ;$$

wherein w is a range that determines neighboring nodes of v_i. By solving the minimization problem in the above equation, Φ(V)∈R^{|V|×d} may be obtained. |V|=u+v represents all nodes in the network. A matrix X of (u+v)×d may be used for representing a mapping function Φ(V).

In some embodiments, the matrix X is expressed as:

$$X = Φ ( \{ V 1 , V 2 \} ) ∈ {R}^{( u + v ) \times d} ;$$

$$and$$

$$X = [ \begin{matrix}{X}_{1} \\ {X}_{2}\end{matrix} ] ;$$

wherein X₁∈R^{u×d} represents an embedding matrix representing nodes of the first object type; and X₂∈R^{v×d} represents an embedding matrix representing nodes of the second object type. The embedding matrix representing nodes of the first object type obtained from the embedding learning process for the bipartite network is denoted as X₁ in FIG. 4, and the embedding matrix representing nodes of the second object type obtained from the embedding learning process for the bipartite network is denoted as X₂ in FIG. 4.

In some embodiments, performing an embedding learning process for the first multi-view homogeneous network includes processing the first multi-view homogeneous network which includes M number of views, View 1, . . . , View m, . . . , View M, 1<m<M. Optionally, a set of M number of views may be expressed as {G₁ₘ|m=1, 2, . . . , M}. A number of nodes of the first object type in a respective view of the M number of views is u. Referring to FIG. 4, the M number of views of the first multi-view homogeneous network are denoted as S₁¹, S₁², . . . , S₁^{M}.

In some embodiments, an adjacent matrix of the first multi-view homogeneous network may be expressed as {A₁ₘ|m=1, 2, . . . , M}∈{0,1}^{u×u}. Optionally, if a i-th node and a j-th node in the respective view are associated to each other, or have interaction with each other, or have a similarity that is not zero, A₁ₘ(i, j)=x, (0<x≤1). Optionally, if a i-th node and a j-th node in the respective view are not associated to each other, and do not have interaction with each other, and have a similarity that is zero, then A₁ₘ(i, j)=0.

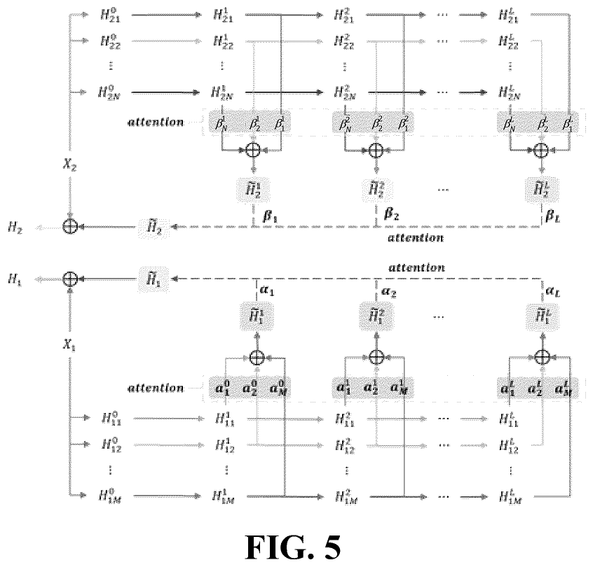

FIG. 5 is a diagram illustrating a node representation learning process in some embodiments according to the present disclosure. Referring to FIG. 4 and FIG. 5, in some embodiments, an initialized node embedding of the first multi-view homogeneous network G₁ₘ includes the embedding matrix X₁∈R^{u×d} representing nodes of the first object type output from the embedding learning process for the bipartite network, wherein u stands for a number of nodes of the first object type in a respective view of the M number of views of the first multi-view homogeneous network, and d stands for a feature dimension of an initialized node embedding corresponding to a respective node. The initialized node embedding of the first multi-view homogeneous network G₁ₘ may be expressed as H₁ₘ⁰|(m=1, 2, . . . , M)=X₁. Referring to FIG. 4, the embedding matrix X₁∈R_{u×d} representing nodes of the first object type output from the embedding learning process for the bipartite network is denoted as X₁.

In some embodiments, the embedding learning process for the first multi-view homogeneous network is performed using a GCN. GCN is a multilayer connected neural network architecture used to learn data from low-dimensional representations of graph structures of nodes. Each layer of the GCN is a direct aggregation of information about connected neighbors through the graph, using the reconstructed embeddings as input to the next layer. The spectral graph convolution theorem defines a convolution in the Fourier domain based on the normalized graph Laplacian operator,

$$L = I - {D}^{- \frac{1}{2}} Ã {D}^{- \frac{1}{2}} = {D}^{- \frac{1}{2}} ( D - \tilde{A} ) {D}^{- \frac{1}{2}} ,$$

wherein l stands for a unit matrix; D=diag(ΣᵢÃ(i, j)) stands for a degree matrix; and

$${D}^{- \frac{1}{2}} Ã$$

stands for an asymmetric matrix representing a transfer probability matrix. Because the degree distribution of nodes in a heterogeneous information network may vary considerably, the asymmetric matrix

$$P = {D}^{- \frac{1}{2}} Ã$$

replaces symmetric L.

In some embodiments, a Fourier basis of the transfer probability matrix P is used to convolve each of resulting networks, respectively. Optionally, P=Φ∧Φ⁻¹, wherein ∧ is an eigenvector matrix of the transfer probability matrix P, and Φ is a diagonal matrix of eigenvalues of P. The resulting convolution on each network is defined as follows:

$${G}_{θ} ⋆ {H}^{0} = {G}_{θ} ( P ) {H}^{0} ;$$

$$= {G}_{θ} ( Φ Λ {Φ}^{- 1} ) {H}^{0} ;$$

$$= Φ {G}_{θ} ( Λ ) {Φ}^{- 1} {H}^{0} ;$$

wherein G_{θ}*H⁰ is a product of a signal H⁰ in a Fourier domain of the graph with a filter G_{θ}, representing an output of a graph convolution; Φ⁻¹ H⁰ stands for a Fourier transform of the signal H⁰. In order to convolve local neighbors of a target node, G_{θ}(∧) is defined as a polynomial filter of order K:

G_{θ}(∧)=Σₖ₌₁^{K}θₖ∧^{k}.
θ∈R^{K} is a vector of polynomial coefficients, thus:

G_{θ}*H⁰=Φ(Σₖ₌₁^{K}θₖ∧^{k})Φ⁻¹H⁰=Σₖ₌₁^{K}θₖP^{k}H⁰.

In some embodiments, G is a network having an adjacency matrix Ã, a convolution on G depends only on nodes that are at most K steps away from the target node. Optionally, the output signal after the convolution operation is defined by a K-step approximation of the local spectral filter on the network. The filtering parameter θ^{k} can be shared across the entire network G. In some embodiments, the convolution operation of the network G is defined as:

H₁ₘ¹=σ(Σₖ₌₁^{K}P₁ₘ^{k}H₁ₘ⁰W₁ₘ⁰);

wherein W₁ₘ⁰∈R^{d×d} stands for a trainable weight matrix of layer 0; H₁ₘ¹∈R^{u×d} stands for a first layer node embedding matrix; d stands for an output node embedding dimension; σ(·) stands for an activation function, using a ReLU(·) function.

H₁ₘ^{l+1}=f(H₁ₘ^{l})=σ(Σₖ₌₁^{K}P₁ₘ^{k}H₁ₘ^{l}W₁ₘ^{l});

wherein H₁ₘ^{l}∈R^{u×d} stands for a l-th layer node embedding matrix; W₁ₘ^{l}∈R^{d×d} stands for a trainable weight parameter matrix for the l-th layer node embedding matrix; H₁ₘ^{l+1}∈R^{u×d} stands for a (l+1)-th layer node embedding matrix.

In some embodiments, performing an embedding learning process for the second multi-view homogeneous network includes processing the second multi-view homogeneous network which includes N number of views, View 1, . . . , View n, . . . , View N, 1<n<N. Optionally, a set of N number of views may be expressed as {G₂ₙ|n=1, 2, . . . , N}. A number of nodes of the second object type in a respective view of the N number of views is v. Referring to FIG. 4, the N number of views of the second multi-view homogeneous network are denoted as S₂¹, S₂², . . . , S₂^{N}.

In some embodiments, an adjacent matrix of the second multi-view homogeneous network may be expressed as {A₂ₙ|n=1, 2, . . . , N}∈{0,1} ^{v×v}. Optionally, if a i-th node and a j-th node in the respective view are associated to each other, or have interaction with each other, or have a similarity that is not zero, A₂ₙ(i, j)=x, (0<x≤1). Optionally, if a i-th node and a j-th node in the respective view are not associated to each other, and do not have interaction with each other, and have a similarity that is zero, then A₂ₙ(i, j)=0.

Referring to FIG. 4 and FIG. 5, in some embodiments, an initialized node embedding of the second multi-view homogeneous network G₂ₘ includes the embedding matrix X₂ ∈ R^{v×d} representing nodes of the second object type output from the embedding learning process for the bipartite network, wherein v stands for a number of nodes of the second object type in a respective view of the N number of views of the second multi-view homogeneous network, and d stands for a feature dimension of an initialized node embedding corresponding to a respective node. The initialized node embedding of the second multi-view homogeneous network G₂ₘ may be expressed as H₂ₙ⁰|(n=1, 2, . . . , N)=X₂. Referring to FIG. 4, the embedding matrix X₂∈R^{v×d} representing nodes of the second object type output from the embedding learning process for the bipartite network is denoted as X₂.

In some embodiments, the convolution operation of the network G is defined as:

H₂ₙ¹=σ(Σₖ₌₁^{K}P₂ₙ^{k}H₂ₙ⁰W₂ₙ⁰);

wherein W₂ₙ⁰, ∈R^{a×d} stands for a trainable weight matrix of layer 0; H₂ₙ¹∈R^{u×d} stands for a first layer node embedding matrix; d stands for an output node embedding dimension; σ(·) stands for an activation function, using a ReLU (·) function.

H₂ₙ^{l+1}=f(H₂ₙ^{l})=σ(Σₖ₌₁^{K}P₂ₙ^{k}H₂ₙ^{l}W₂ₙ^{l}).

wherein H₂ₙ^{l}∈R^{u×d} stands for a l-th layer node embedding matrix; W₂ₙ^{l}∈R^{a×d} stands for a trainable weight parameter matrix for the l-th layer node embedding matrix; H₂ₙ^{l+1}∈R^{u×d} stands for a (l+1)-th layer node embedding matrix.

In some embodiments, with respect to multiple homogeneous views having a same set of nodes, multiple paths of different types exist. For example, in View 1, node 1 is directly connected to node 2. In View 2, node 1 is not directly connected to node 2, but is indirectly connected to node 2 through node 3, for example, through a path of “node 1→node 3→node 2”. In some embodiments, in a respective view, a respective node contains only semantic information specific to a type of the respective view. Node embedding for that particular semantic can only reflect the respective node in a specific way. In order to learn the node embedding in a more comprehensive manner, multiple semantics that can be displayed through multiple paths under multiple views are fused.

To address the problem of path selection and fusion of semantic information in multi-view networks, the present disclosure further provides a novel semantic-level attention mechanism that can automatically learn the importance under different view paths and use it for the problem of predicting association relationships between two different object types of nodes in the bipartite network. With regard to the embedding learning process for the first multi-view homogeneous network, there are M number of types of multi-view paths between nodes of the first object types. The attention mechanism according to the present disclosure is configured to derive outputs from the M number of homogeneous networks.

Attention mechanism is inspired by the way the human brain processes information. When processing information received from the outside world, the human brain often focuses its attention on key information of high value and interest. It can be seen as a combinatorial function that highlights the impact of a key input on the output by calculating the probability distribution of attention. Attention mechanism may be implemented in deep learning tasks such as natural language processing (NLP) (e.g., Encoder-Decoder framework for natural language processing tasks), image recognition, speech recognition, and graph-based machine learning tasks.

Referring to FIG. 4, M sets of semantically-specific node embeddings of the first object type learned from M homogeneous view networks in the embedding learning process for the first multi-view homogeneous network are input into the attention mechanism. The M sets of semantically-specific node embeddings of the first object type learned from M homogeneous view networks in the embedding learning process for the first multi-view homogeneous network are denoted as ME in FIG. 4. In some embodiments, learning weights (α₁^{l}, α₂^{l}, . . . , α_{M}^{l}) of multiple paths can be expressed as follows:

(α₁^{l},α₂^{l}, . . . ,α_{M}^{l})=αttₛₑₘ(H₁₁^{l},H₁₂^{l}, . . . ,H_{1M}^{l}),l=0,1,2, . . . ;

wherein αttₛₑₘ stands for a method of performing semantic level attention; (α₁^{l}, α₂^{l}, . . . , α_{M}^{l}) stands for a feature matrix learned by nodes of the first object type under M number of types of multi-view paths according to levels of nodes and levels of attentions; (H₁₁^{l}, H₁₂^{l}, . . . , H_{1M}^{l}) stands for feature representations of nodes of the first object type extracted from the M homogeneous views; and l stands for a l-th layer of the attention mechanism. Various types of semantic information contained in various meta-paths in the heterogeneous network may be obtained through semantic level attention. In order to understand the importance of each meta-path, a non-linear transformation is performed on H₁ₘ^{l}, and H₁ₘ^{l} is transformed into embeddings of all nodes in the m-th view network:

$${w}_{m} = \frac{1}{\vert {V}_{m} \vert} {Σ}_{i ∈ {V}_{m}} {q}^{T} \cdot tanh ( W \cdot {H}_{1 m}^{l} ( i ) + bi ) ;$$

wherein W stands for a weight matrix, b stands for a bias vector, q^{T} stands for a semantic level trainable weight vector to measure the similarity between embedding representations under multiple meta-paths, and H₁ₘ^{l}(i) stands for a feature representation of a node i of the first object type under meta-path m. Vₘ stands for nodes of the first object type in the m-th bipartite network. After obtaining the importance of each meta-path, the importance of each meta-path is normalized by a softmax function. By normalizing the importance of all meta-paths using the softmax function, the weights under the m-th meta-path can be obtained:

$${a}_{m}^{l} = \frac{exp ( {w}_{m} )}{{Σ}_{m = 1}^{M} exp ( {w}_{m} )} ;$$

The weights can be understood as contribution of different meta-paths. The higher αₘ^{l} is, the more important the meta-path m is.

In some embodiments, using the learned weights (α₁^{l}, α₂^{l}, . . . , α_{M}^{l}) as coefficients, different low dimensional feature representations of nodes of the first object type under different meta-paths are fused by a l-th layer of the attention mechanism to obtain a final low dimensional embedding representation of the nodes of the first object type from the l-th layer of the attention mechanism, as follows:

$${\tilde{H}}_{1}^{l} = {Σ}_{m = 1}^{M} {a}_{m}^{l} \cdot {H}_{1 m}^{l} .$$

wherein l stands for a l-th layer of the attention mechanism.

Referring to FIG. 4, N sets of semantically-specific node embeddings of the second object type learned from N homogeneous view networks in the embedding learning process for the second multi-view homogeneous network are input into the attention mechanism. The N sets of semantically-specific node embeddings of the second object type learned from N homogeneous view networks in the embedding learning process for the second multi-view homogeneous network are denoted as NE in FIG. 4. In some embodiments, learning weights (β₁^{l}, β₂^{l}, . . . , β_{N}^{l}) of multiple paths can be expressed as follows:

(β₁^{l},β₂^{l}, . . . ,β_{N}^{l})=αttₛₑₘ(H₂₁^{l},H₂₂^{l}, . . . ,H_{2N}^{l}),l=0,1,2, . . . ;

wherein αttₛₑₘ stands for a method of performing semantic level attention; (β₁^{l}, β₂^{l}, . . . , β_{N}^{l}) stands for a feature matrix learned by nodes of the second object type under N number of types of multi-view paths according to levels of nodes and levels of attentions; (H₂₁^{l}, H₂₂^{l}, . . . , H_{2N}^{l}) stands for feature representations of nodes of the second object type extracted from the N homogeneous views; and l stands for a l-th layer of the attention mechanism. Various types of semantic information contained in various meta-paths in the heterogeneous network may be obtained through semantic level attention. In order to understand the importance of each meta-path, a non-linear transformation is performed on H₂ₙ^{l}, and H₂ₙ^{l} is transformed into embeddings of all nodes in the n-th view network:

$${w}_{n} = \frac{1}{\vert {V}_{n} \vert} {\sum }_{i ∈ {V}_{n}} {q}^{T} \cdot tanh ( W \cdot {H}_{2 n}^{l} ( i ) + bi ) ;$$

wherein W stands for a weight matrix, b stands for a bias vector, q^{T} stands for a semantic level trainable weight vector to measure the similarity between embedding representations under multiple meta-paths, and H₂ₙ^{l}(i) stands for a feature representation of a node i of the second object type under meta-path n. Vₙ stands for nodes of the second object type in the n-th bipartite network. After obtaining the importance of each meta-path, the importance of each meta-path is normalized by a softmax function. By normalizing the importance of all meta-paths using the softmax function, the weights under the n-th meta-path can be obtained:

$${β}_{n}^{l} = \frac{exp ( {w}_{n} )}{{\sum }_{n = 1}^{N} exp ( {w}_{n} )} ;$$

The weights can be understood as contribution of different meta-paths. The higher βₙ^{l} is, the more important the meta-path n is.

In some embodiments, using the learned weights (β₁^{l}, β₂^{l}, . . . , β_{N}^{l}) as coefficients, different low dimensional feature representations of nodes of the second object type under different meta-paths are fused by a l-th layer of the attention mechanism to obtain a final low dimensional embedding representation of the nodes of the second object type from the l-th layer of the attention mechanism, as follows:

$${\tilde{H}}_{2}^{l} = {\sum }_{n = 1}^{N} {β}_{n} \cdot {H}_{2 n}^{l} .$$

wherein l stands for a l-th layer of the attention mechanism.

Different layers of the convolution operation contribute to the representation of the node embedding differently. In some embodiments, the method further includes aggregating embedding representation of different layers using the attention mechanism. With regard to the nodes of the first object type, the low dimensional embedding representation is aggregated as \tilde{H}₁=Σₗ₌₁^{L}αₗ\tilde{H}₁^{l}; wherein l stands for a l-th layer of the attention mechanism; L stands for a total number of layers in the attention mechanism. The embedding representation of nodes of the first object type obtained from the embedding learning process for the first multi-view homogeneous network is denoted as \tilde{H}₁ in FIG. 4. With regard to the nodes of the second object type, the low dimensional embedding representation is aggregated as \tilde{H}₂=Σₗ₌₁^{L}βₗ\tilde{H}₂^{l}; wherein l stands for a l-th layer of the attention mechanism; L stands for a total number of layers in the attention mechanism. The embedding representation of nodes of the second object type obtained from the embedding learning process for the second multi-view homogeneous network is denoted as \tilde{H}₂ in FIG. 4. With regard to the first multi-view homogeneous network, a first node embedding matrix is expressed as \tilde{H}₁∈R^{u×d} With regard to the second multi-view homogeneous network, a second node embedding matrix is expressed as \tilde{H}₂∈R^{v×d}. αₗ and βₗ are automatically learned, and are initialized to 1/(l+1), l=1,2, . . . , L.

Node embedding learned in the embedding learning process for the bipartite network is obtained by learning an explicit relationship between the nodes of two object types. The node embedding learned in the embedding learning process for the bipartite network and the node embedding learned in the embedding learning process for the first multi-view homogeneous network are combined to obtain node embedding representation of the nodes of the first object type: H₁=\tilde{H}₁+X₁; wherein \tilde{H}₁∈R^{u×d} represents an embedding matrix representing nodes of the first object type learned in the embedding learning process for the first multi-view homogeneous network; and X₁∈R^{u×d} represents an embedding matrix representing nodes of the first object type learned in the embedding learning process for the bipartite network. The combined node embedding representation of the nodes of the first object type is denoted as H₁ in FIG. 4.

The node embedding learned in the embedding learning process for the bipartite network and the node embedding learned in the embedding learning process for the second multi-view homogeneous network are combined to obtain node embedding representation of the nodes of the second object type: H₂=\tilde{H}₂+X₂; wherein \tilde{H}₂∈R^{v×d} represents an embedding matrix representing nodes of the second object type learned in the embedding learning process for the second multi-view homogeneous network; and X₂∈R^{v×d} represents an embedding matrix representing nodes of the second object type learned in the embedding learning process for the bipartite network. The combined node embedding representation of the nodes of the second object type is denoted as H₂ in FIG. 4.

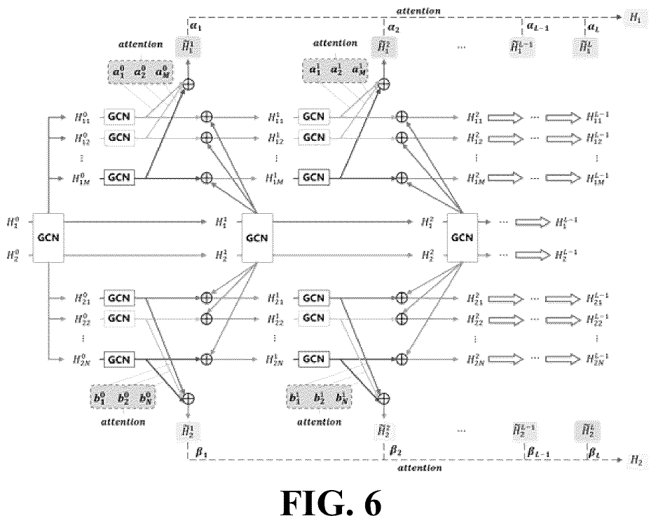

FIG. 6 is a diagram illustrating a node representation learning process in some embodiments according to the present disclosure. Referring to FIG. 1 to FIG. 4, and FIG. 6, in some embodiments, the embedding learning process for the bipartite network comprises obtaining node representations for the nodes of two different object types in the bipartite network. Optionally, the embedding learning process for the bipartite network includes processing an association network comprising known associations of the nodes of two different object types in the bipartite network (“Known Associations of Node1 to Node2” denoted in FIG. 4). In one example, the association network may be denoted as G, nodes of the first object type may be denoted as u, and nodes of the second object type may be denoted as v.

In some embodiments, an adjacent matrix A of the association network includes known associations between nodes of the first object type and nodes of the second object type. Optionally, if a node of the nodes of the first object type and a node of the nodes of the second object type are associated to each other, A (i, j)=1. Optionally, if a node of the nodes of the first object type and a node of the nodes of the second object type are not associated to each other, A(i, j)=0. The adjacent matrix A may be expressed as:

$${H}^{0} = [ \begin{matrix}{H}_{1}^{0} \\ {H}_{2}^{0}\end{matrix} ] = [ \begin{matrix}0 & A \\ {A}^{T} & 0\end{matrix} ] ;$$

wherein H₁⁰ stands for nodes of the first object type and H₂⁰ stands for nodes of the second object type.

An adjacent matrix based on all nodes in the bipartite network may be expressed as:

$$\tilde{A} = [ \begin{matrix}0 & A \\ {A}^{T} & 0\end{matrix} ] ;$$

wherein 0 in the adjacent matrix means absence of an edge between nodes of a same type.

In some embodiments, the initialized node embedding of the association network is H⁰∈R^{(u+v)×(u+v)}, wherein R stands for a set of relationship types, u stands for a number of nodes of the first object type in a respective view of the M number of views of the first multi-view homogeneous network, and v stands for a number of nodes of the second object type in a respective view of the N number of views of the second multi-view homogeneous network.

Optionally, the initialized node embedding of the association network may be expressed as:

$$[ \begin{matrix}{H}_{1}^{0} \\ {H}_{2}^{0}\end{matrix} ] = [ \begin{matrix}0 & A \\ {A}^{T} & 0\end{matrix} ] ;$$

wherein H₁⁰∈R^{u×(u+v)}, H₂⁰∈R^{u×(u+v)}, H₁⁰ stands for nodes of the first object type, and H₂⁰ stands for nodes of the second object type.

In some embodiments, the embedding learning process is performed using a GCN. In some embodiments, the convolution operation of the network G is defined as:

H¹=σ(Σₖ₌₁^{K}P^{k}H⁰W⁰);

wherein W⁰∈R^{(u+v)×d} stands for a trainable weight matrix of layer 0; H¹∈R^{(u+v)×d} stands for a first layer node embedding matrix; d stands for an output node embedding dimension; σ(·) stands for an activation function, using a ReLU(·) function.

H₁ₘ^{l+1}=f(H₁ₘ^{l})=σ(Σₖ₌₁^{K}P₁ₘ^{k}H₁ₘ^{l}W₁ₘ^{l});H^{l+1}=f(H^{l})=σ(Σₖ₌₁^{K}P^{k}H^{l}W^{l});

wherein H^{l}∈R^{u×d} stands for a l-th layer node embedding matrix; W^{l}∈R^{d×d} stands for a trainable weight parameter matrix for the l-th layer node embedding matrix; H^{l+1}∈R^{u×d} stands for a (l+1)-th layer node embedding matrix; and 1=1, 2, . . . , L−1.

In some embodiments,

$${H}^{l} = [ \begin{matrix}{H}_{1}^{l} \\ {H}_{2}^{l}\end{matrix} ] ;$$

wherein H₁^{l} stands for nodes of the first object type, and H₂^{l} stands for nodes of the second object type.

In some embodiments, performing an embedding learning process for the first multi-view homogeneous network includes processing the first multi-view homogeneous network which includes M number of views, View 1, . . . , View m, . . . , View M, 1<m<M. Optionally, a set of M number of views may be expressed as {G₁ₘ|m=1, 2, . . . , M}. A number of nodes of the first object type in a respective view of the M number of views is u. Referring to FIG. 4, the M number of views of the first multi-view homogeneous network are denoted as S₁¹, S₁², . . . .

In some embodiments, an adjacent matrix of the first multi-view homogeneous network may be expressed as {A₁ₘ|m=1, 2, . . . , M}∈{0,1}^{u×u}. Optionally, if a i-th node and a j-th node in the respective view are associated to each other, or have interaction with each other, or have a similarity that is not zero, A₁ₘ(i, j)=x, (0<x≤1). Optionally, if a i-th node and a j-th node in the respective view are not associated to each other, and do not have interaction with each other, and have a similarity that is zero, then A₁ₘ(i, j)=0.

Referring to FIG. 4 and FIG. 6, in some embodiments, an initialized node embedding of the first multi-view homogeneous network G₁ₘ includes the embedding matrix X₁∈R^{u×d} representing nodes of the first object type output from the embedding learning process for the bipartite network, wherein u stands for a number of nodes of the first object type in a respective view of the M number of views of the first multi-view homogeneous network, and d stands for a feature dimension of an initialized node embedding corresponding to a respective node. The initialized node embedding of the first multi-view homogeneous network G₁ₘ may be expressed as H₁ₘ⁰|(m=1, 2, . . . , M)=X₁. Referring to FIG. 4, the embedding matrix X₁∈R^{u×d} representing nodes of the first object type output from the embedding learning process for the bipartite network is denoted as X₁.

In some embodiments, a 0-th layer of the initialized node embedding of the first multi-view homogeneous network G₁ₘ may be expressed as:

\tilde{H}₁ₘ=σ(Σₖ₌₁^{K}P₁ₘ^{k}H₁ₘ⁰W₁ₘ⁰);

wherein W₁ₘ⁰∈R^{a×d} stands for a trainable weight matrix of layer 0; H₁ₘ⁰∈R^{u×d} stands for a node embedding matrix of layer 0; d stands for an output node embedding dimension; σ(·) stands for an activation function, using a ReLU(·) function.

Because the adjacent matrix having the associations between nodes of the first object type and nodes of the second object type is updated with embedding representation of the nodes of the first type, an input to a next layer (e.g., a 1st layer) can be defined as:

$${H}_{1 m}^{1} = {\tilde{H}}_{1 m}^{0} + {H}_{1}^{1} ;$$

$${\tilde{H}}_{1 m}^{l} = f ( {H}_{1 m}^{l} ) = σ ( {\sum }_{k = 1}^{K} {P}_{1 m}^{k} {H}_{1 m}^{l} {W}_{1 m}^{l} ) ;$$

wherein H₁ₘ^{l}∈R^{u×d} stands for a l-th layer node embedding matrix; W₁ₘ^{l}∈R^{d×d} stands for a trainable weight parameter matrix for the l-th layer node embedding matrix; \tilde{H}₁ₘ^{l}∈R^{u×d} stands for a learned node embedding matrix output from the l-th layer.

In some embodiments, an input to a (l+1)-th layer may be defined as:

$${H}_{1 m}^{l + 1} = {\tilde{H}}_{1 m}^{l} + {H}_{1}^{l + 1} .$$

Referring to FIG. 4, M sets of semantically-specific node embeddings of the first object type learned from M homogeneous view networks in the embedding learning process for the first multi-view homogeneous network are input into the attention mechanism. The M sets of semantically-specific node embeddings of the first object type learned from M homogeneous view networks in the embedding learning process for the first multi-view homogeneous network are denoted as ME in FIG. 4. In some embodiments, learning weights (α₁^{l}, α₂^{l}, . . . , α_{M}^{l}) of multiple paths can be expressed as follows:

(α₁^{l},α₂^{l}, . . . ,α_{M}^{l})=αttₛₑₘ(H₁₁^{l},H₁₂^{l}, . . . ,H_{1M}^{l}),l=0,1,2, . . . ;

wherein αttₛₑₘ stands for a method of performing semantic level attention; (α₁^{l}, α₂^{l}, . . . , α_{M}^{l}) stands for a feature matrix learned by nodes of the first object type under M number of types of multi-view paths according to levels of nodes and levels of attentions; (H₁₁^{l}, H₁₂^{l}, . . . , H_{1M}^{l}) stands for feature representations of nodes of the first object type extracted from the M homogeneous views; and l stands for a l-th layer of the attention mechanism. Various types of semantic information contained in various meta-paths in the heterogeneous network may be obtained through semantic level attention. In order to understand the importance of each meta-path, a non-linear transformation is performed on Him, and Him is transformed into embeddings of all nodes in the m-th view network:

$${w}_{m} = \frac{1}{\vert {V}_{m} \vert} {\sum }_{i ∈ {V}_{m}} {q}^{T} \cdot tanh ( W \cdot {H}_{1 m}^{l} ( i ) + bi ) ;$$

wherein W stands for a weight matrix, b stands for a bias vector, q^{T} stands for a semantic level trainable weight vector to measure the similarity between embedding representations under multiple meta-paths, and H₁ₘ^{l}(i) stands for a feature representation of a node i of the first object type under meta-path m. Vₘ stands for nodes of the first object type in the m-th bipartite network. After obtaining the importance of each meta-path, the importance of each meta-path is normalized by a softmax function. By normalizing the importance of all meta-paths using the softmax function, the weights under the m-th meta-path can be obtained:

$${a}_{m}^{l} = \frac{exp ( {w}_{m} )}{{\sum }_{m = 1}^{M} exp ( {w}_{m} )} ;$$

The weights can be understood as contribution of different meta-paths. The higher αₘ^{l} is, the more important the meta-path m is.

In some embodiments, using the learned weights (α₁^{l}, α₂^{l}, . . . , α_{M}^{l}) as coefficients, different low dimensional feature representations of nodes of the first object type under different meta-paths are fused by a l-th layer of the attention mechanism to obtain a final low dimensional embedding representation of the nodes of the first object type from the l-th layer of the attention mechanism, as follows:

$${\tilde{H}}_{1}^{l} = {\sum }_{m = 1}^{M} {a}_{m}^{l} \cdot {H}_{1 m}^{l} .$$

wherein l stands for a l-th layer of the attention mechanism.

In some embodiments, performing an embedding learning process for the second multi-view homogeneous network includes processing the second multi-view homogeneous network which includes N number of views, View 1, . . . , View n, . . . , View N, 1<n<N. Optionally, a set of N number of views may be expressed as {G₂ₙ|n=1, 2, . . . , N}. A number of nodes of the second object type in a respective view of the N number of views is v. Referring to FIG. 4, the N number of views of the second multi-view homogeneous network are denoted as S₂¹, S₂², . . . , S₂^{N}.

In some embodiments, an adjacent matrix of the second multi-view homogeneous network may be expressed as {A₂ₙ|n=1, 2, . . . , N}∈{0,1}^{v×v}. Optionally, if a i-th node and a j-th node in the respective view are associated to each other, or have interaction with each other, or have a similarity that is not zero, A₂ₙ(i, j)=x, (0<x≤1). Optionally, if a i-th node and a j-th node in the respective view are not associated to each other, and do not have interaction with each other, and have a similarity that is zero, then A₂ₙ(i, j)=0.

Referring to FIG. 4 and FIG. 5, in some embodiments, an initialized node embedding of the second multi-view homogeneous network G₂ₘ includes the embedding matrix X₂∈R^{v×d} representing nodes of the second object type output from the embedding learning process for the bipartite network, wherein v stands for a number of nodes of the second object type in a respective view of the N number of views of the second multi-view homogeneous network, and d stands for a feature dimension of an initialized node embedding corresponding to a respective node. The initialized node embedding of the second multi-view homogeneous network G₂ₘ may be expressed as H₂ₙ⁰|(n=1, 2, . . . , N)=X₂. Referring to FIG. 4, the embedding matrix X₂∈R^{v×d} representing nodes of the second object type output from the embedding learning process for the bipartite network is denoted as X₂.

In some embodiments, a 0-th layer of the initialized node embedding of the second multi-view homogeneous network G₂ₘ may be expressed as:

\tilde{H}₂ₙ⁰=σ(Σₖ₌₁^{K}P₂ₙ^{k}H₂ₙ⁰W₂ₙ⁰));

wherein W₂ₙ⁰∈R^{d×d} stands for a trainable weight matrix of layer 0; H₂ₙ⁰∈R^{u×d} stands for a node embedding matrix of layer 0; d stands for an output node embedding dimension; σ(·) stands for an activation function, using a ReLU(·) function.

Because the adjacent matrix having the associations between nodes of the first object type and nodes of the second object type is updated with embedding representation of the nodes of the second type, an input to a next layer (e.g., a 1st layer) can be defined as:

$${H}_{2 n}^{1} = {\tilde{H}}_{2 n}^{0} + {H}_{2 n}^{0} ;$$

$${\tilde{H}}_{2 n}^{l} = f ( {H}_{2 n}^{l} ) = σ ( {\sum }_{k = 1}^{K} {P}_{2 n}^{k} {H}_{2 n}^{l} {W}_{2 n}^{l} ) ;$$

wherein Han d stands for a l-th layer node embedding matrix; W₂ₙ^{l}∈R^{d×d} stands for a trainable weight parameter matrix for the l-th layer node embedding matrix; H₂ₙ^{l+1}∈R^{u×d} stands for a (l+1)-th layer node embedding matrix.

In some embodiments, an input to a (l+1)-th layer may be defined as:

$${H}_{2 n}^{l + 1} = {\tilde{H}}_{2 n}^{l} + {H}_{2}^{l + 1} .$$

Referring to FIG. 4, N sets of semantically-specific node embeddings of the second object type learned from N homogeneous view networks in the embedding learning process for the second multi-view homogeneous network are input into the attention mechanism. The N sets of semantically-specific node embeddings of the second object type learned from N homogeneous view networks in the embedding learning process for the second multi-view homogeneous network are denoted as NE in FIG. 4. In some embodiments, learning weights (β₁^{l}, β₂^{l}, . . . , β_{N}^{l}) of multiple paths can be expressed as follows:

(β₁^{l},β₂^{l}, . . . ,β_{N}^{l})=αttₛₑₘ(H₂₁^{l},H₂₂^{l}, . . . ,H_{2N}^{l}),l=0,1,2, . . . ;

wherein αttₛₑₘ stands for a method of performing semantic level attention; (β₁^{l}, β₂^{l}, . . . , β_{N}^{l}) stands for a feature matrix learned by nodes of the second object type under N number of types of multi-view paths according to levels of nodes and levels of attentions; (H₂₁^{l}, H₂₂^{l}, . . . , H_{2N}^{l}) stands for feature representations of nodes of the second object type extracted from the N homogeneous views; and l stands for a l-th layer of the attention mechanism. Various types of semantic information contained in various meta-paths in the heterogeneous network may be obtained through semantic level attention. In order to understand the importance of each meta-path, a non-linear transformation is performed on H₂ₙ^{l}, and H₂ₙ^{l} is transformed into embeddings of all nodes in the n-th view network:

$${w}_{n} = \frac{1}{\vert {V}_{n} \vert} {\sum }_{i ∈ {V}_{n}} {q}^{T} \cdot tanh ( W \cdot {H}_{2 n}^{l} ( i ) + bi ) ;$$

wherein W stands for a weight matrix, b stands for a bias vector, q^{T} stands for a semantic level trainable weight vector to measure the similarity between embedding representations under multiple meta-paths, and H₂ₙ^{l}(i) stands for a feature representation of a node i of the second object type under meta-path n. Vₙ stands for nodes of the second object type in the n-th bipartite network. After obtaining the importance of each meta-path, the importance of each meta-path is normalized by a softmax function. By normalizing the importance of all meta-paths using the softmax function, the weights under the n-th meta-path can be obtained:

$${β}_{n}^{l} = \frac{exp ( {w}_{n} )}{{Σ}_{n = 1}^{N} exp ( {w}_{n} )} ;$$

The weights can be understood as contribution of different meta-paths. The higher βₙ^{l} is, the more important the meta-path n is.

In some embodiments, using the learned weights (β₁^{l}, β₂^{l}, . . . , β_{N}^{l}) as coefficients, different low dimensional feature representations of nodes of the second object type under different meta-paths are fused by a l-th layer of the attention mechanism to obtain a final low dimensional embedding representation of the nodes of the second object type from the l-th layer of the attention mechanism, as follows:

$${\tilde{H}}_{2}^{l} = {Σ}_{n = 1}^{N} {β}_{n}^{l} \cdot {H}_{2 n}^{l} .$$

wherein l stands for a l-th layer of the attention mechanism.

Different layers of the convolution operation contribute to the representation of the node embedding differently. In some embodiments, the method further includes aggregating embedding representation of different layers using the attention mechanism. With regard to the nodes of the first object type, the low dimensional embedding representation is aggregated as \tilde{H}₁=Σₗ₌₁^{L}αₗ\tilde{H}₁^{l}; wherein l stands for a l-th layer of the attention mechanism; L stands for a total number of layers in the attention mechanism. The embedding representation of nodes of the first object type obtained from the embedding learning process for the first multi-view homogeneous network is denoted as \tilde{H}₁ in FIG. 4. With regard to the nodes of the second object type, the low dimensional embedding representation is aggregated as \tilde{H}₂=Σₗ₌₁^{L}βₗ\tilde{H}₂^{l}; wherein l stands for a l-th layer of the attention mechanism; L stands for a total number of layers in the attention mechanism. The embedding representation of nodes of the second object type obtained from the embedding learning process for the second multi-view homogeneous network is denoted as \tilde{H}₂ in FIG. 4. With regard to the first multi-view homogeneous network, a first node embedding matrix is expressed as \tilde{H}₁∈R^{u×d}. With regard to the second multi-view homogeneous network, a second node embedding matrix is expressed as \tilde{H}₂∈R^{v×d}. αₗ and βₗ are automatically learned, and are initialized to 1/(l+1), l=1,2, . . . , L.

Node embedding learned in the embedding learning process for the bipartite network is obtained by learning an explicit relationship between the nodes of two object types. The node embedding learned in the embedding learning process for the bipartite network and the node embedding learned in the embedding learning process for the first multi-view homogeneous network are combined to obtain node embedding representation of the nodes of the first object type: H₁=\tilde{H}₁+X₁; wherein \tilde{H}₁∈R^{u×d} represents an embedding matrix representing nodes of the first object type learned in the embedding learning process for the first multi-view homogeneous network; and X₁∈R^{u×d} represents an embedding matrix representing nodes of the first object type learned in the embedding learning process for the bipartite network. The combined node embedding representation of the nodes of the first object type is denoted as H₁ in FIG. 4.

The node embedding learned in the embedding learning process for the bipartite network and the node embedding learned in the embedding learning process for the second multi-view homogeneous network are combined to obtain node embedding representation of the nodes of the second object type: H₂=\tilde{H}₂+X₂; wherein \tilde{H}₂∈R^{v×d} represents an embedding matrix representing nodes of the second object type learned in the embedding learning process for the second multi-view homogeneous network; and X₂∈R^{v×d} represents an embedding matrix representing nodes of the second object type learned in the embedding learning process for the bipartite network. The combined node embedding representation of the nodes of the second object type is denoted as H₂ in FIG. 4.

In some embodiments, the method is implemented using graph convolutional neural network (GCN). Through an adjacent matrix having the associations between nodes of the first object type and nodes of the second object type, a first layer of the GCN is used to learn the node embedding representation of the nodes of the first object type, and the node embedding representation of the nodes of the second object type. The node embedding representation of the nodes of the first object type and the node embedding representation of the nodes of the second object type are input as initial data into a similarity matrix of a first type and a similarity matrix of a second type, and the corresponding embeddings of the nodes are learned using the graph convolutional neural network model. Weights [α₁, α₂, . . . , α_{M}] and [β₁, β₂, . . . , β_{N}] for the nodes of the first object type and the nodes of the second object type are learned using attention mechanism under the similarity matrix of the first type and the similarity matrix of the second type, respectively. The inputs of the first and second class similarity matrices of a (l+1)-th layer are the outputs of a l-th layer, in addition to the node embedding representation of the nodes of the first object type, and the node embedding representation of the nodes of the second object type output from adjacent matrices of the l-th layer. The process is reiterated for L number of times. Weights of different layers are learned in the L-th layer based on attention mechanism. The weighted sum is obtained, and is used to obtain the final node embedding representation of the nodes of the first object type, and the final node embedding representation of the nodes of the second object type.

In some embodiments, nodes of the first object type are drugs, and nodes of the second object type are diseases. The present method may be used to predict drug-disease association. Drug-disease association prediction is useful in facilitating drug design, which is typically a very tedious and costly process. There are only a few successful examples of drug design cases. Researchers are exploring new approaches such as drug repurposing or repositioning to develop new therapies for treating or preventing diseases.

Drug repositioning (also known as drug repurposing or drug reconfiguration) is a process of using an existing drug for treating a new disease, commonly known as “new use of an old drug”. Drug repositioning can significantly reduce costs compared to traditional drug development methods. A significant advantage of drug repositioning is that the safety profile of the repositioned drug is known because the chemical has already undergone extensive safety testing, thus reducing the risk of drug development failure. Moreover, repositioned drugs save the early costs and time required to bring a drug to market, thereby speeding up the transition from research and early development to clinical trial.

A 2016 study by the German accounting law firm Deloitte & Touche showed that the return on investment for pharmaceutical R&D giants fell from 10.1% in 2010 to 3.7% in 2016. At the same time, the average cost of developing a new drug has increased from just under $1.2 billion to $1.54 billion, with development taking 14 years. It currently takes 13-15 years to bring a new drug to market, costing between US$2-3 billion, and costs are rising. Some findings suggest that the average cost of repositioning a drug is only US$300 million and that it takes about 6.5 years to reach the market.

In drug repurposing approaches, the potential therapeutic power of drugs is discovered through a variety of methods, including computational methods, clinical trials, as well as in vitro methods. For example, Viagra and Thalidomide were originally designed to reduce pulmonary hypertension and tension, but were later discovered to be effective treatments of erectile dysfunction and leprosy.

The application of information technology has led to several efficient drug repurposing methods being proposed, including molecular modelling methods and data mining methods. For example, molecular docking methods are used to investigate how drugs and targets bind to each other and how much energy exists between them. Various software applications have been developed for this purpose, depending on the needs and technologies. Data mining methods have also been successfully used to uncover latent relationships between drugs and targets. The information obtained is thus used to discover drugs that can affect specific biological targets. These techniques are usually divided into three main categories, including text mining-based methods, machine learning based methods, and network-based methods.

In some embodiments, the present disclosure provides a drug-disease association prediction method. The method in some embodiments includes modeling biological data (e.g., metabolic pathways, drug-target interactions, protein-protein interactions) as a network for obtaining new information (e.g., latent drug-disease association) and in turn developing new therapeutic uses of drugs. With the latent drug-disease association uncovered, disease- and gene-related information such as information contained in databases (e.g., MalaCards and DisGeNET) can be used to discover new therapeutic benefits of existing drugs.

In some embodiments, the network-based drug-disease association prediction methods may use a drug-disease association matrix alone, or additionally with a drug-drug similarity matrix and/or a disease-disease similarity matrix, to learn the low-dimensional embedding matrix of drug nodes and disease nodes. Embedding representations of the drug nodes and the disease nodes are obtained respectively based on the low-dimensional embedding matrix of the drug nodes and the disease nodes. The drug-disease associations are predicted based on the low-dimensional embedding representation of the drug nodes and the disease nodes. The drug-disease associations prediction may be expressed as a mathematical model of predicting latent edge connections between drug nodes and disease nodes in a drug-disease dichotomous graph.

The inventors of the present disclosure discover that approaches in which similarities are treated by taking direct summation to obtain the average sum or simple splicing operations do not produce a useful prediction results, even with the aid of experiments to provide empirical parameters such as weighing parameters.

Accordingly, the present disclosure provides a novel method of predicting drug-disease associations, based on the observation that different similarities contribute to the prediction results differently. In some embodiments, the present method includes constructing a heterogeneous network comprising one or more similarity matrixes. Optionally, the one or more similarity matrixes include a first similarity matrix among nodes of a first object type and a second similarity matrix among nodes of a second object type.

In some embodiments, the first similarity matrix is a drug-drug similarity matrix among drugs. The first similarity matrix in some embodiments includes at least one of chemical structure similarities, anatomical therapeutic chemical (ATC) classification similarities, side effect similarities, drug-drug interaction similarities, or drug target similarities.

Chemical structure similarity measures the similarity of a compound, using a chemical development kit (CDK) to calculate the structural quality of a drug. In some embodiments, chemical structure similarities may be obtained by calculating hash fingerprints of the drugs, and calculating similarity scores based on the hash fingerprints of the drugs. In one example, the Canonical SMILES file for the drugs of interest may be downloaded from a database (e.g., DrugBank). The CDK tool is used to calculate the hash fingerprints of all drugs with default parameters. Tanimoto similarity scores are calculated based on the hash fingerprints. The Tanimoto similarity score may be used to represent the chemical structure similarities of the drugs.

Drugs are classified using the World Health Organization (WHO) ATC classification system. The ATC classification system classifies drugs according to their therapeutic effects and chemical properties on organs or systems. ATC classification codes may be obtained from various appropriate databases such as DrugBank. Two drugs are considered to have a higher similarity when their respective ATC classification codes have a higher similarity. A semantic similarity algorithm may be used to calculate the similarity between the ATC classification codes.

Information on side effects of drugs may be extracted from various appropriate databases such as the SIDER database. In one example, side effects of a given drug is represented by a summary file listing all known side effects. In another example, side effect similarity may be calculated using the Jaccard similarity coefficient. In one particular example, the similarity of side effects of drugs i and j may be calculated according to:

$${R}_{s e} ( i , j ) = \frac{\vert S {E}_{i} ⋂ S {E}_{j} \vert}{\vert S {E}_{i} ⋃ S {E}_{j} \vert} ;$$

wherein SEᵢ stands for a set of side effects of drug i, SEⱼ stands for a set of side effects of drug j, and Rₛₑ(i, j) stands for side effect similarity between drug i and drug j.

Drug-drug interactions may be extracted from various appropriate databases such as DrugBank. In one example, drug-drug interaction of each drug is represented by an interaction profile, consisting of all drugs known to interact with a particular drug. In another example, drug-drug interaction similarity may be calculated based on the Jaccard score of the drug-drug interaction profile. In one particular example, the drug-drug interaction similarity of drugs i and j may be calculated according to:

$${R}_{d d i} ( i , j ) = \frac{\vert D D {I}_{i} ⋂ D D {I}_{j} \vert}{\vert D D {I}_{i} ⋃ D D {I}_{j} \vert} ;$$

wherein DDIᵢ stands for an interaction profile of drug i, DDIⱼ stands for an interaction profile of drug j, and R_{ddi}(i, j) stands for drug-drug interaction similarity between drug i and drug j.

Drug target information may be extracted from various appropriate databases such as DrugBank. In one example, drug target information is represented by a target spectra of a particular drug, which includes all known relevant target regions of the particular drug. In another example, the drug target similarity may be calculated based on the Jaccard score of the target regions. In one particular example, the drug target similarity of drugs i and j may be calculated according to:

$${R}_{dti} ( i , j ) = \frac{\vert D T {I}_{i} ⋂ D T {I}_{j} \vert}{\vert D T {I}_{i} ⋃ D T {I}_{j} \vert} ;$$

wherein DTIᵢ stands for a target spectra of drug i, DTIⱼ stands for a target spectra of drug j, and R_{dti}(i, j) stands for drug target similarity between drug i and drug j.

In some embodiments, the second similarity matrix is a disease-disease similarity matrix among diseases. The second similarity matrix in some embodiments includes at least one of disease phenotypic similarities, or gene ontology similarities.

Disease phenotypic similarities may be extracted from various appropriate databases such as MimMiner. In some embodiments, the extracted disease phenotypic similarities are normalized to a value in range of [0,1]. In another example, similarity scores between two diseases were calculated based on the frequency of medical subject word terms in medical descriptions.

Gene ontology similarities are important annotations of human genes and can be used to describe relationships between diseases. In some embodiments, gene ontology terms are organized into directed acyclic graphs; and semantic similarity between two diseases is measured by their relative positions in the directed acyclic graphs. Based on the structure of the gene ontology terms, gene ontology similarity is calculated using a gene ontology-based algorithm.

In some embodiments, subsequent to constructing the heterogeneous network comprising one or more similarity matrixes as described above, the method further includes an encoding process, which is analogous to the embedding learning process described in the present disclosure, e.g., the process depicted in FIG. 2. In some embodiments, nodes of the first object type are drug nodes, and nodes of the second object type are disease nodes. The node embedding representation of the nodes of the first object type is the node embedding representation of the drug nodes, and the node embedding representation may be denoted as H_{R}. The node embedding representation of the nodes of the second object type is the node embedding representation of the disease nodes, and the node embedding representation may be denoted as H_{D}.

In some embodiments, subsequent to the encoding process, the method further includes a decoding process to reconstruct drug-disease associations. Various appropriate decoders may be used for reconstructing drug-disease associations. FIG. 4 shows an example of a multi-layer perceptron (MLP) based decoder.

In some embodiments, a decoder f(H_{R}, H_{D}) may be used for decoding. In one example, the decoder f(H_{R}, H_{D}) may be formulated as:

A′=f(H_{R},H_{D})=sigmoid(H_{R}H_{D}^{T});

wherein A′∈R^{u×v} stands for a prediction probability score matrix; the associations between drug rᵢ and disease dⱼ is derived from a corresponding A′ᵢⱼ; H_{R} stands for an embedding matrix of drug nodes; H_{D} stands for an embedding matrix of disease nodes.

In some embodiments, the method further includes an optimization process. Known drug-disease associations that have been manually validated are highly reliable and important for improving predictive performance. Accordingly, in some embodiments, the manually validated known drug-disease associations may be used in the optimization process. In some embodiments, a loss function is used in the optimization process.

The number of known drug-disease associations is much smaller than the number of unknown or unobserved drug-disease pairs. In some embodiments, the method learns the parameters by minimizing a weighted binary cross-entropy loss as follows:

$$loss = - \frac{1}{u \times v} ( γ \times {Σ}_{( i , j ) ∈ {S}^{+}} log {A}_{i j}^{′} + {Σ}_{( i , j ) ∈ {S}^{-}} ( 1 - log {A}_{i j}^{′} ) ) ;$$

wherein (i, j) stands for a pair of drug rᵢ and disease dⱼ; S⁺ stands for a set of all known drug-disease association pairs; S⁻ stands for a set of all unknown or unobserved drug-disease association pairs;

$$γ = \frac{\vert {S}^{-} \vert}{\vert {S}^{+} \vert}$$

stands for a balancing factor for reducing an effect of data imbalance, |S⁺| and |S⁻| are the logarithms in S⁺ and S⁻, respectively. In one example, the model is optimized by means of the Adam optimizer.

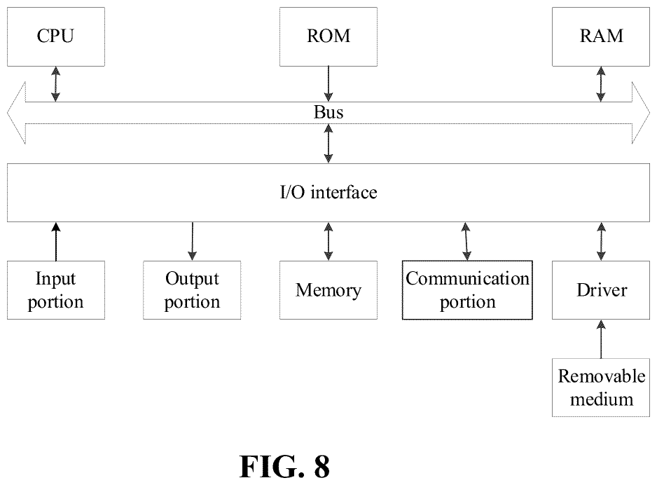

In another aspect, the present disclosure provides an apparatus for managing production of one or more products. FIG. 8 is a schematic diagram of a structure of an apparatus in some embodiments according to the present disclosure. Referring to FIG. 8, in some embodiments, the apparatus includes the central processing unit (CPU) configured to perform actions according to the computer-executable instructions stored in a ROM or in a RAM. Optionally, data and programs required for a computer system are stored in RAM. Optionally, the CPU, the ROM, and the RAM are electrically connected to each other via bus. Optionally, an input/output interface is electrically connected to the bus.

In some embodiments, the apparatus includes a memory, and one or more processors, wherein the memory and the one or more processors are connected with each other. In some embodiments, the memory stores computer-executable instructions for controlling the one or more processors to obtain a bipartite network; a first multi-view homogeneous network; and a second multi-view homogeneous network; perform an embedding learning process for the bipartite network; perform an embedding learning process for the first multi-view homogeneous network; perform an embedding learning process for the second multi-view homogeneous network; and predict association relationships between the nodes of a first object type and the nodes of a second object type.

In some embodiments, the bipartite network comprises nodes of a first object type, nodes of a second object type, and edges connecting the nodes of the first object type and the nodes of the second object type.

In some embodiments, the first multi-view homogeneous network comprises a first set of networks composed of nodes of a first object type, in which edges between a same pair of nodes of the first type are observed in different views. Optionally, the second multi-view homogeneous network comprises a second set of networks composed of nodes of the second object type, in which edges between a same pair of nodes of the second type are observed in different views.

In some embodiments, the memory further stores computer-executable instructions for controlling the one or more processors to obtain an embedding matrix representing nodes of a first object type learned in the embedding learning process for the bipartite network; obtain an embedding matrix representing nodes of a second object type learned in the embedding learning process for the bipartite network; obtain an embedding matrix representing nodes of the first object type learned in the embedding learning process for the first multi-view homogeneous network; and obtain an embedding matrix representing nodes of the second object type learned in the embedding learning process for the second multi-view homogeneous network.

In some embodiments, the memory further stores computer-executable instructions for controlling the one or more processors to combine the embedding matrix representing nodes of the first object type learned in the embedding learning process for the bipartite network and the embedding matrix representing nodes of the first object type learned in the embedding learning process for the first multi-view homogeneous network; and combine the embedding matrix representing nodes of the second object type learned in the embedding learning process for the bipartite network and the embedding matrix representing nodes of the second object type learned in the embedding learning process for the second multi-view homogeneous network.

In some embodiments, the memory further stores computer-executable instructions for controlling the one or more processors to input an embedding matrix representing nodes of a first object type learned in the embedding learning process for the bipartite network into the first multi-view homogeneous network as an initialized node embedding of the first multi-view homogeneous network; and input an embedding matrix representing nodes of a second object type learned in the embedding learning process for the bipartite network into the second multi-view homogeneous network as an initialized node embedding of the second multi-view homogeneous network.

In some embodiments, the memory further stores computer-executable instructions for controlling the one or more processors to input M sets of node embeddings of the first object type learned from M homogeneous view networks in the embedding learning process for the first multi-view homogeneous network into an attention mechanism; and determine weights assigned to M homogeneous views respectively by the attention mechanism.

In some embodiments, the weights assigned to the M homogeneous views respectively are expressed as (β₁^{l}, β₂^{l}, . . . , β_{M}^{l})=αttₛₑₘ(H₁₁^{l}, H₁₂^{l}, . . . , H_{1M}^{l}), l=0,1,2, . . . ; wherein (β₁^{l}, β₂^{l}, . . . , β_{M}^{l}) stands for a weight matrix comprising the weights assigned to the M homogeneous views respectively; αttₛₑₘ stands for a method of performing semantic level attention; (H₁₁^{l}, H₁₂^{l}, . . . , H_{1M}^{l}) stands for feature representations of nodes of the first object type extracted from the M homogeneous views; and l stands for a l-th layer of the attention mechanism.

In some embodiments, the memory further stores computer-executable instructions for controlling the one or more processors to perform a non-linear transformation on H₁ₘ^{l}, to transform H₁ₘ^{l} into embeddings of all nodes in a m-th view network of the M homogeneous view networks.

In some embodiments, the memory further stores computer-executable instructions for controlling the one or more processors to fuse, by a l-th layer of the attention mechanism, different low dimensional feature representations of nodes of the first object type under different meta-paths, using the weights assigned to the M homogeneous views respectively; and obtain a low dimensional embedding representation of the nodes of the first object type from the l-th layer of the attention mechanism \tilde{H}₁^{l}=Σₘ₌₁^{M}αₘ^{l}·H₁ₘ^{l}.

In some embodiments, the memory further stores computer-executable instructions for controlling the one or more processors to input N sets of node embeddings of the second object type learned from N homogeneous view networks in the embedding learning process for the second multi-view homogeneous network into an attention mechanism; and determine weights assigned to N homogeneous views respectively by the attention mechanism.

In some embodiments, the weights assigned to the N homogeneous views respectively are expressed as (β₁^{l}, β₂^{l}, . . . , β_{N}^{l})=αttₛₑₘ(H₂₁^{l}, H₂₂^{l}, . . . , H_{2N}^{l}), l=0,1,2, . . . ; wherein (β₁^{l}, β₂^{l}, . . . , β_{N}^{l}) stands for a weight matrix comprising the weights assigned to the N homogeneous views respectively; αttₛₑₘ stands for a method of performing semantic level attention; (H₂₁^{l}, H₂₂^{l}, . . . , H_{2N}^{l}) stands for feature representations of nodes of the second object type extracted from the N homogeneous views; and l stands for a l-th layer of the attention mechanism.

In some embodiments, the memory further stores computer-executable instructions for controlling the one or more processors to perform a non-linear transformation on H₂ₙ^{l}, to transform H₂ₙ^{l} into embeddings of all nodes in a n-th view network of the N homogeneous view networks.

In some embodiments, the memory further stores computer-executable instructions for controlling the one or more processors to fuse, by a l-th layer of the attention mechanism, different low dimensional feature representations of nodes of the second object type under different meta-paths, using the weights assigned to the N homogeneous views respectively; and obtain a low dimensional embedding representation of the nodes of the second object type from the l-th layer of the attention mechanism \tilde{H}₂^{l}=Σ_{N=1}^{N}βₙ^{l}·H₂ₙ^{l}.

In some embodiments, the memory further stores computer-executable instructions for controlling the one or more processors to extract node representations of nodes of the first object type and nodes of the second object type by inputting pairs of nodes; learning sequence representations of nodes; and outputting vector representations of nodes.

In some embodiments, learning sequence representations of nodes is performed using a random walk algorithm. Optionally, the vector representations of the nodes are obtained using a skip-gram model.

In some embodiments, the nodes of a first object type are drug nodes; the nodes of the second object type are disease nodes. Optionally, the heterogeneous network includes one or more drug-drug similarity matrixes and one or more disease-disease similarity matrixes. Optionally, the memory further stores computer-executable instructions for controlling the one or more processors to perform a decoding process to reconstruct association relationships between the nodes of a first object type and the nodes of a second object type.

In some embodiments, the memory further stores computer-executable instructions for controlling the one or more processors to minimize a weighted binary cross-entropy loss:

$$loss = - \frac{1}{u \times v} ( γ \times {Σ}_{( i , j ) ∈ {S}^{+}} log {A}_{i j}^{′} + {Σ}_{( i , j ) ∈ {S}^{-}} ( 1 - log {A}_{i j}^{′} ) ) ;$$

wherein (i, j) stands for a pair of drug rᵢ and disease dⱼ; S⁺ stands for a set of all known drug-disease association pairs; S⁻ stands for a set of all unknown or unobserved drug-disease association pairs;

$$γ = \frac{\vert {S}^{-} \vert}{\vert {S}^{+} \vert}$$

stands for a balancing factor for reducing an effect of data imbalance; and |S⁺| and |S⁻| are the logarithms in S⁺ and S⁻, respectively.

In another aspect, the present disclosure provides a computer-program product including a non-transitory tangible computer-readable medium having computer-readable instructions thereon. In some embodiments, the computer-readable instructions being executable by a processor to cause the processor to perform obtaining a bipartite network; a first multi-view homogeneous network; and a second multi-view homogeneous network; performing an embedding learning process for the bipartite network; performing an embedding learning process for the first multi-view homogeneous network; performing an embedding learning process for the second multi-view homogeneous network; and predicting association relationships between the nodes of a first object type and the nodes of a second object type.

In some embodiments, the bipartite network comprises nodes of a first object type, nodes of a second object type, and edges connecting the nodes of the first object type and the nodes of the second object type.

In some embodiments, the first multi-view homogeneous network comprises a first set of networks composed of nodes of a first object type, in which edges between a same pair of nodes of the first type are observed in different views. Optionally, the second multi-view homogeneous network comprises a second set of networks composed of nodes of the second object type, in which edges between a same pair of nodes of the second type are observed in different views.

In some embodiments, the computer-readable instructions are executable by a processor to cause the processor to further perform obtaining an embedding matrix representing nodes of a first object type learned in the embedding learning process for the bipartite network; obtaining an embedding matrix representing nodes of a second object type learned in the embedding learning process for the bipartite network; obtaining an embedding matrix representing nodes of the first object type learned in the embedding learning process for the first multi-view homogeneous network; and obtaining an embedding matrix representing nodes of the second object type learned in the embedding learning process for the second multi-view homogeneous network.

In some embodiments, the computer-readable instructions are executable by a processor to cause the processor to further perform combining the embedding matrix representing nodes of the first object type learned in the embedding learning process for the bipartite network and the embedding matrix representing nodes of the first object type learned in the embedding learning process for the first multi-view homogeneous network; and combining the embedding matrix representing nodes of the second object type learned in the embedding learning process for the bipartite network and the embedding matrix representing nodes of the second object type learned in the embedding learning process for the second multi-view homogeneous network.

In some embodiments, the computer-readable instructions are executable by a processor to cause the processor to further perform inputting an embedding matrix representing nodes of a first object type learned in the embedding learning process for the bipartite network into the first multi-view homogeneous network as an initialized node embedding of the first multi-view homogeneous network; and inputting an embedding matrix representing nodes of a second object type learned in the embedding learning process for the bipartite network into the second multi-view homogeneous network as an initialized node embedding of the second multi-view homogeneous network.

In some embodiments, the computer-readable instructions are executable by a processor to cause the processor to further perform inputting M sets of node embeddings of the first object type learned from M homogeneous view networks in the embedding learning process for the first multi-view homogeneous network into an attention mechanism; and determining weights assigned to M homogeneous views respectively by the attention mechanism.

In some embodiments, the weights assigned to the M homogeneous views respectively are expressed as (α₁^{l}, α₂^{l}, . . . , α_{M}^{l})=αttₛₑₘ(H₁₁^{l}, H₁₂^{l}, . . . , H_{1M}^{l}), l=0,1,2, . . . ; wherein (α₁^{l}, α₂^{l}, . . . , α_{M}^{l}) stands for a weight matrix comprising the weights assigned to the M homogeneous views respectively; αttₛₑₘ stands for a method of performing semantic level attention; (H₁₁^{l}, H₁₂^{l}, . . . , H_{1M}^{l}) stands for feature representations of nodes of the first object type extracted from the M homogeneous views; and l stands for a l-th layer of the attention mechanism.

In some embodiments, the computer-readable instructions are executable by a processor to cause the processor to further perform a non-linear transformation on H₁ₘ^{l}, to transform H₁ₘ^{l} into embeddings of all nodes in a m-th view network of the M homogeneous view networks.

In some embodiments, the computer-readable instructions are executable by a processor to cause the processor to further perform fusing, by a l-th layer of the attention mechanism, different low dimensional feature representations of nodes of the first object type under different meta-paths, using the weights assigned to the M homogeneous views respectively; and obtaining a low dimensional embedding representation of the nodes of the first object type from the l-th layer of the attention mechanism \tilde{H}₁^{l}=Σₘ₌₁^{M}αₘ^{l}·H₁ₘ^{l}.

In some embodiments, the computer-readable instructions are executable by a processor to cause the processor to further perform inputting N sets of node embeddings of the second object type learned from N homogeneous view networks in the embedding learning process for the second multi-view homogeneous network into an attention mechanism; and determining weights assigned to N homogeneous views respectively by the attention mechanism.

In some embodiments, the weights assigned to the N homogeneous views respectively are expressed as (β₁^{l}, β₂^{l}, . . . , β_{N}^{l})=αttₛₑₘ(H₂₁^{l}, H₂₂^{l}, . . . , H_{2N}^{l}), l=0,1,2, . . . ; wherein (β₁^{l}, β₂^{l}, . . . , β_{N}^{l}) stands for a weight matrix comprising the weights assigned to the N homogeneous views respectively; αttₛₑₘ stands for a method of performing semantic level attention; (H₂₁^{l}, H₂₂^{l}, . . . , H_{2N}^{l}) stands for feature representations of nodes of the second object type extracted from the N homogeneous views; and l stands for a l-th layer of the attention mechanism.

In some embodiments, the computer-readable instructions are executable by a processor to cause the processor to further perform a non-linear transformation on H₂ₙ^{l}, to transform H₂ₙ^{l} into embeddings of all nodes in a n-th view network of the N homogeneous view networks.

In some embodiments, the computer-readable instructions are executable by a processor to cause the processor to further perform fusing, by a l-th layer of the attention mechanism, different low dimensional feature representations of nodes of the second object type under different meta-paths, using the weights assigned to the N homogeneous views respectively; and obtaining a low dimensional embedding representation of the nodes of the second object type from the l-th layer of the attention mechanism \tilde{H}₂^{l}=Σₙ₌₁^{N}βₙ^{l}·H₂ₙ^{l}.

In some embodiments, the computer-readable instructions are executable by a processor to cause the processor to further perform extracting node representations of nodes of the first object type and nodes of the second object type by inputting pairs of nodes; learning sequence representations of nodes; and outputting vector representations of nodes.

In some embodiments, learning sequence representations of nodes is performed using a random walk algorithm. Optionally, the vector representations of the nodes are obtained using a skip-gram model.

In some embodiments, the nodes of a first object type are drug nodes; the nodes of the second object type are disease nodes. Optionally, the heterogeneous network includes one or more drug-drug similarity matrixes and one or more disease-disease similarity matrixes. Optionally, the computer-readable instructions are executable by a processor to cause the processor to further perform a decoding process to reconstruct association relationships between the nodes of a first object type and the nodes of a second object type.

In some embodiments, the computer-readable instructions are executable by a processor to cause the processor to further perform minimizing a weighted binary cross-entropy loss:

$$loss = - \frac{1}{u \times v} ( γ \times {Σ}_{( i , j ) ∈ {S}^{+}} log {A}_{i j}^{′} + {Σ}_{( i , j ) ∈ {S}^{-}} ( 1 - log {A}_{i j}^{′} ) ) ;$$

wherein (i, j) stands for a pair of drug rᵢ; and disease dⱼ; S⁺ stands for a set of all known drug-disease association pairs; S⁻ stands for a set of all unknown or unobserved drug-disease association pairs;

$$γ = \frac{\vert {s}^{-} \vert}{\vert {s}^{+} \vert}$$

stands for a balancing factor for reducing an effect of data imbalance; and |S⁺| and |S⁻| are the logarithms in S⁺ and S⁻, respectively.

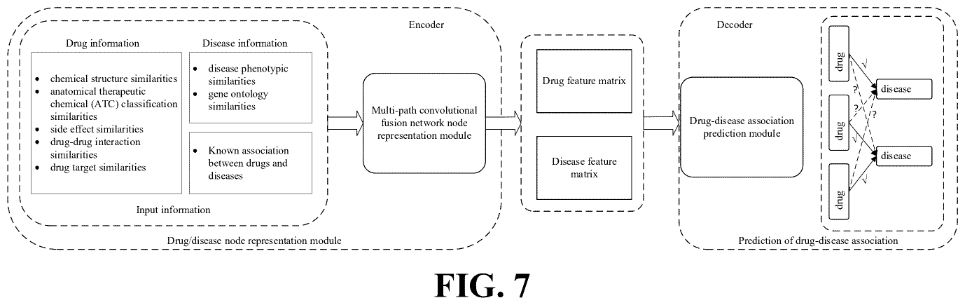

FIG. 7 is a schematic diagram of a structure of an apparatus in some embodiments according to the present disclosure. Referring to FIG. 7, the apparatus in some embodiments includes an encoder and a decoder. The encoder is configured to perform an embedding learning process (e.g., the “drug-disease node representation module”). The decoder is configured to predict the drug-disease association. The encoder is configured to receive input information including drug information and disease information. The encoder further includes a multi-path convolutional fusion network node representation module configured to generate a drug feature matrix (e.g., node embedding representation of drug nodes) and a disease feature matrix (e.g., node embedding representation of disease nodes). The decoder in some embodiments includes a drug-disease association prediction module configured to predict the drug-disease association.

Various illustrative operations described in connection with the configurations disclosed herein may be implemented as electronic hardware, computer software, or combinations of both. Such operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A computer-implemented method, comprising:
obtaining a bipartite network; a first multi-view homogeneous network; and a second multi-view homogeneous network;
performing an embedding learning process for the bipartite network;
performing an embedding learning process for the first multi-view homogeneous network;
performing an embedding learning process for the second multi-view homogeneous network; and
predicting association relationships between nodes of a first object type and nodes of a second object type.

2. The computer-implemented method of claim 1, wherein the bipartite network comprises nodes of a first object type, nodes of a second object type, and edges connecting the nodes of the first object type and the nodes of the second object type.

3. The computer-implemented method of claim 1, wherein the first multi-view homogeneous network comprises a first set of networks composed of nodes of a first object type, in which edges between a same pair of the nodes of the first type are observed in different views; and
the second multi-view homogeneous network comprises a second set of networks composed of the nodes of the second object type, in which edges between a same pair of nodes of the second type are observed in different views.

4. The computer-implemented method of claim 1, further comprising:
obtaining an embedding matrix representing the nodes of the first object type learned in the embedding learning process for the bipartite network;
obtaining an embedding matrix representing the nodes of the second object type learned in the embedding learning process for the bipartite network;
obtaining an embedding matrix representing the nodes of the first object type learned in the embedding learning process for the first multi-view homogeneous network; and
obtaining an embedding matrix representing the nodes of the second object type learned in the embedding learning process for the second multi-view homogeneous network.

5. The computer-implemented method of claim 2, further comprising:
combining an embedding matrix representing the nodes of the first object type learned in the embedding learning process for the bipartite network and an embedding matrix representing the nodes of the first object type learned in the embedding learning process for the first multi-view homogeneous network; and
combining an embedding matrix representing the nodes of the second object type learned in the embedding learning process for the bipartite network and an embedding matrix representing the nodes of the second object type learned in the embedding learning process for the second multi-view homogeneous network.

6. The computer-implemented method of claim 1, further comprising:
inputting an embedding matrix representing nodes of a first object type learned in the embedding learning process for the bipartite network into the first multi-view homogeneous network as an initialized node embedding of the first multi-view homogeneous network; and
inputting an embedding matrix representing nodes of a second object type learned in the embedding learning process for the bipartite network into the second multi-view homogeneous network as an initialized node embedding of the second multi-view homogeneous network.

7. The computer-implemented method of claim 1, wherein performing the embedding learning process for the first multi-view homogeneous network comprises:
inputting M sets of node embeddings of the first object type learned from M homogeneous view networks in the embedding learning process for the first multi-view homogeneous network into an attention mechanism; and
determining weights assigned to M homogeneous views respectively by the attention mechanism.

8. The computer-implemented method of claim 7, wherein the weights assigned to M homogeneous views respectively are expressed as:
(α₁^{l},α₂^{l}, . . . α_{M}^{l})=αttₛₑₘ(H₁₁^{l},H₁₂^{l}, . . . ,H_{1M}^{l}),l=0,1,2, . . . ;
wherein (α₁^{l}, α₂^{l}, . . . α_{M}^{l}) stands for a weight matrix comprising the weights assigned to the M homogeneous views respectively;
αttₛₑₘ stands for a method of performing semantic level attention;
(H₁₁^{l}, H₁₂^{l}, . . . , H_{1M}^{l}) stands for feature representations of nodes of the first object type extracted from the M homogeneous views; and
l stands for a l-th layer of the attention mechanism.

9. The computer-implemented method of claim 8, wherein determining the weights assigned to the M homogeneous views respectively comprises performing a non-linear transformation on H_{1M}^{l}, to transform H_{1M}^{l} into embeddings of all nodes in a m-th view network of the M homogeneous view networks.

10. The computer-implemented method of claim 7, further comprising:
fusing, by a l-th layer of the attention mechanism, different low dimensional feature representations of nodes of the first object type under different meta-paths, using the weights assigned to M homogeneous views respectively; and
obtaining a low dimensional embedding representation of the nodes of the first object type from a l-th layer of the attention mechanism:
$${\tilde{H}}_{1}^{l} = {Σ}_{m = 1}^{M} {α}_{m}^{l} \cdot {H}_{1 m}^{l} .$$

11. The computer-implemented method of claim 1, wherein performing the embedding learning process for the second multi-view homogeneous network comprises:
inputting N sets of node embeddings of the second object type learned from N homogeneous view networks in the embedding learning process for the second multi-view homogeneous network into an attention mechanism; and
determining weights assigned to N homogeneous views respectively by the attention mechanism.

12. The computer-implemented method of claim 11, wherein the weights assigned to N homogeneous views respectively are expressed as:
(β₁^{l},β₂^{l}, . . . ,β_{N}^{l})=αttₛₑₘ(H₂₁^{l},H₂₂^{l}, . . . ,H_{2N}^{l}),l=0,1,2, . . . ;
wherein (β₁^{l}, β₂^{l}, . . . ,β_{N}^{l}) stands for a weight matrix comprising the weights assigned to the N homogeneous views respectively;
αttₛₑₘ stands for a method of performing semantic level attention;
(H₂₁^{l},H₂₂^{l}, . . . ,H_{2N}^{l}) stands for feature representations of nodes of the second object type extracted from the N homogeneous views; and
l stands for a l-th layer of the attention mechanism.

13. The computer-implemented method of claim 12, wherein determining the weights assigned to the N homogeneous views respectively comprises performing a non-linear transformation on H₂ₙ^{l}, to transform H₂ₙ^{l} into embeddings of all nodes in a n-th view network of the N homogeneous view networks.

14. The computer-implemented method of claim 11, further comprising:
fusing, by a l-th layer of the attention mechanism, different low dimensional feature representations of nodes of the second object type under different meta-paths, using the weights assigned to N homogeneous views respectively; and
obtaining a low dimensional embedding representation of the nodes of the second object type from a l-th layer of the attention mechanism:
$${\tilde{H}}_{2}^{l} = {Σ}_{n = 1}^{N} {β}_{n}^{l} \cdot {H}_{2 n}^{l} .$$

15. The computer-implemented method of claim 1, wherein performing the embedding learning process for the bipartite network comprises extracting node representations of nodes of the first object type and nodes of the second object type by:
inputting pairs of nodes;
learning sequence representations of nodes; and
outputting vector representations of nodes.

16. The computer-implemented method of claim 15, wherein learning sequence representations of nodes is performed using a random walk algorithm; and
the vector representations of the nodes are obtained using a skip-gram model.

17. The computer-implemented method of claim 2, wherein the nodes of a first object type are drug nodes;
the nodes of the second object type are disease nodes;
wherein the heterogeneous network comprises one or more drug-drug similarity matrixes and one or more disease-disease matrixes;
wherein the method further comprises a decoding process to reconstruct association relationships between the nodes of a first object type and the nodes of a second object type, thereby predicting drug-disease association.

18. The computer-implemented method of claim 17, further comprising minimizing a weighted binary cross-entropy loss:
$$loss = - \frac{1}{u \times v} ( γ \times {Σ}_{( i , j ) ∈ {S}^{+}} log {A}_{i j}^{′} + {Σ}_{( i , j ) ∈ {S}^{-}} ( 1 - log {A}_{i j}^{′} ) ) ;$$
wherein (t, f) stands for a pair of drug rᵢ and disease dⱼ;
S⁺ stands for a set of all known drug-disease association pairs;
S⁻ stands for a set of all unknown or unobserved drug-disease association pairs;
$$γ = \frac{\vert {s}^{-} \vert}{\vert {s}^{+} \vert}$$
stands for a balancing factor for reducing an effect of data imbalance; and

|S⁺| and |S⁻| are logarithms in S⁺ and S⁻, respectively.

19. An apparatus, comprising:
a memory;
one or more processors;
wherein the memory and the one or more processors are connected with each other; and
the memory stores computer-executable instructions for controlling the one or more processors to:
obtain a bipartite network; a first multi-view homogeneous network; and a second multi-view homogeneous network;
perform an embedding learning process for the bipartite network;
perform an embedding learning process for the first multi-view homogeneous network;
perform an embedding learning process for the second multi-view homogeneous network; and
predict association relationships between nodes of a first object type and nodes of a second object type.

20. A computer-program product, comprising a non-transitory tangible computer-readable medium having computer-readable instructions thereon, the computer-readable instructions being executable by a processor to cause the processor to perform:
obtaining a bipartite network; a first multi-view homogeneous network; and a second multi-view homogeneous network;
performing an embedding learning process for the bipartite network;
performing an embedding learning process for the first multi-view homogeneous network;
performing an embedding learning process for the second multi-view homogeneous network; and
predicting association relationships between nodes of a first object type and nodes of a second object type.
